(19) United States
(12) Patent Application Publication
(10) Pub. No.: US 2026/0149379 A1
(43) Pub. Date: May 28, 2026

(54) CONTROL CIRCUIT FOR A MULTIPHASE ELECTRONIC CONVERTER, RELATED INTEGRATED CIRCUIT, MULTIPHASE ELECTRONIC CONVERTER AND METHOD OF OPERATING A MULTIPHASE ELECTRONIC CONVERTER

(71) Applicant: STMicroelectronics International N.V., Geneva (CH)

(72) Inventors: Alessandro BERTOLINI, Vermiglio (IT); Alessandro GASPARINI, Cusano Milanino (IT); Osvaldo Enrico ZAMBETTI, Milano (IT)

(73) Assignee: STMicroelectronics International N.V., Geneva (CH)

(21) Appl. No.: 19/399,909

(22) Filed: Nov. 25, 2025

(30) Foreign Application Priority Data
Nov. 27, 2024 (IT) 102024000026796

(51) Int. Cl. H02M 3/158

(52) U.S. Cl. CPC H02M 3/1584

(57) ABSTRACT

Drive signals for switching stages of a multiphase electronic converter are generated as a function of a PWM signal and a current balancing circuit. The current balancing circuit receives a control clock signal and a reference clock signal from a phase shift circuit. A phase detector generates the PWM signal as a function of the control clock signal received via one or more delay lines and the reference clock signal. Specifically, a regulator circuit of the current balancing circuit varies the delay introduced by the one or more delay lines in order to balance the currents provided by the switching stages of the multiphase electronic converter.

### PRIORITY CLAIM

This application claims the priority benefit of Italian Application for Patent No. 102024000026796 filed on November 27, 2024, the content of which is hereby incorporated by reference in its entirety to the maximum extent allowable by law.

### TECHNICAL FIELD

The embodiments of the present description refer to a control device for a multiphase electronic converter, such as a multiphase buck converter.

### BACKGROUND

Power-supply circuits, such as AC/DC or DC/DC switched mode power supplies, are well known in the art. There exist many types of electronic converters, which are mainly divided into isolated and non-isolated converters. For instance, non-isolated electronic converters are the converters of the "buck", "boost", "buck-boost", "Ćuk", "SEPIC", and "ZETA" type. Instead, isolated converters are, for instance, converters of the "flyback", "forward", "half-bridge", and "full-bridge" type. Such types of converters are well known to the person skilled in the art.

FIG. 1 is a schematic illustration of a DC/DC electronic converter 20. In particular, a generic electronic converter 20 comprises two input terminals 200a and 200b for receiving a DC voltage Vᵢₙ and two output terminals 202a and 202b for supplying a DC voltage Vₒᵤₜ. For example, the input voltage Vᵢₙ may be supplied by a DC voltage source 10, such as a battery, or may be obtained from an AC voltage by means of a rectifier circuit, such as a bridge rectifier, and possibly a filtering circuit. Instead, the output voltage Vₒᵤₜ may be used to supply a load 30.

FIG. 2 shows the circuit schematic of a buck converter 20. In particular, a buck converter 20 comprises two input terminals 200a and 200b for receiving a DC input voltage Vᵢₙ and two output terminals 202a and 202b for supplying a regulated voltage Vₒᵤₜ, where the output voltage is equal to or lower than the input voltage Vᵢₙ.

In the example considered, the buck converter 20 comprises a switching stage 26 connected between the input terminals 200a and 200b and the output terminals 202a and 202b. Specifically, the switching stage 26 comprises two electronic switches Q1 and Q2 (with the current path thereof) connected (e.g., directly) in series between the input terminals 200a and 200b, wherein the intermediate node between the electronic switches Q1 and Q2 represents a switching node Lx. Specifically, the electronic switch Q1 is a high-side switch connected (e.g., directly) between the (positive) terminal 200a and the switching node Lx, and the electronic switch Q2 is a low-side switch connected (e.g., directly) between the switching node Lx and the (negative) terminal 200b, which often represents a ground GND. The (high-side) switch Q1 and the (low-side) switch Q2 hence represent a half-bridge configured to connect the switching node Lx to the terminal 200a (voltage Vᵢₙ) or the terminal 200b (ground GND). Often the electronic switch Q2 comprises or is replaced with a diode D.

In the example considered, the switching stage 26 comprises an inductance L, such as an inductor, connected (e.g., directly) between the switching node Lx and the (positive) output terminal 202a. Instead, the (negative) output terminal 202b is connected (e.g., directly) to the (negative) input terminal 200b. In the example considered, to stabilize the output voltage Vₒᵤₜ, the switching stage 26 comprises a capacitor Cₒᵤₜ connected (e.g., directly) between the output terminals 202a and 202b.

In this context, FIG. 3 shows exemplary waveforms of the signals of such an electronic converter, where: waveform a) of FIG. 3 shows the signal DRV₁ for switching the electronic switch Q1; waveform b) of FIG. 3 shows the signal DRV₂ for switching the second electronic switch Q2; waveform c) of FIG. 3 shows the current I_{Q1} that traverses the electronic switch Q1; waveform d) of FIG. 3 shows the voltage V_{Lx} at the switching node Lx (i.e., the voltage at the second switch Q2); and waveform e) of FIG. 3 shows the current I_{L} that traverses the inductor L.

In particular, when the electronic switch Q1 is closed at an instant t₁ (ON state), the current I_{L} in the inductor L increases (substantially) linearly. The electronic switch Q2 is at the same time opened. Instead, when the electronic switch Q1 is opened after an interval T_{ON1} at an instant t₂ (OFF state), the electronic switch Q2 is closed, and the current I_{L} decreases (substantially) linearly. Finally, the switch Q1 is closed again after an interval T_{OFF1}. In the example considered, the switch Q2 is hence closed when the switch Q1 is open. The current I_{L} may thus be used to charge the capacitor Cₒᵤₜ, which supplies the voltage Vₒᵤₜ at the terminals 202a and 202b.

In the example considered, the electronic converter 20 comprises thus a control circuit 22 configured to drive the switching of the switch Q1 and of the switch Q2, for repeating the intervals T_{ON1} and T_{OFF1} periodically. For example, typically the buck converter 20 comprises also a feedback circuit (FBC) 24, such as a voltage divider, configured to generate a feedback signal FB indicative of (and preferably proportional to) the output voltage Vₒᵤₜ, and the control circuit 22 is configured to generate the drive signals DRV₁ and DRV₂ by comparing the feedback signal FB with a reference signal, such as a reference voltage V_{ref}.

A significant number of driving schemes are known for generating the drive signals DRV₁ and DRV₂. These solutions have in common the possibility of regulating the output voltage Vₒᵤₜ by regulating the duration of the interval T_{ON1} and/or the interval T_{OFF1}. For example, in various solutions, the control circuit 22 generates a Pulse-Width Modulation (PWM) signal DRV₁, wherein the duty-cycle T_{ON1}/(T_{ON1} + T_{OFF1}) is variable. Generally, the switching period T_{SW} = T_{ON1} + T_{OFF1} may be constant or variable. For example, a typical control scheme involves that the switching period T_{SW} is constant and the duration of the interval T_{ON1} is varied via a regulator circuit having at least an integral component, such as a Proportional-Integral (PI) or Proportional-Integral-Derivative (PID) regulator.

In general, a buck converter may be operated in a Continuous-Conduction Mode (CCM), Discontinuous-Conduction Mode (DCM) or Transition Mode (TM).

For example, as shown in FIG. 4, when the control circuit 22 operates the converter in CCM, the current I_{L} flowing through the inductance L has a value different from zero when the switching cycle T_{SW} ends. In this case, the control circuit 22 uses two switching phases T₁ and T₂, with T_{SW} = T₁ + T₂, wherein during the phase T₁ (T₁ = T_{ON1} = T_{OFF2}) the switch Q1 is closed and the switch/diode Q2 is opened, and during the phase T₂ (T₂ = T_{OFF1} = T_{ON2}) the switch Q1 is opened and the switch/diode Q2 is closed.

Conversely, as shown in FIG. 5, when the control circuit 22 operates the converter in in DCM, the control circuit 22 may use three switching phases T₁, T₂ and T₃, with T_{SW} = T₁ + T₂ + T₃, wherein during the phase T₁ (T₁ = T_{ON1}) the switch Q1 is closed and the switch/diode Q2 is opened, during the phase T₂ (T₂ = T_{ON2}) the switch Q1 is opened and the switch/diode Q2 is closed, and during the phase T₃ (T_{OFF1} = T₂ + T₃ and T_{OFF2} = T₃ + T₁) the switch Q1 is opened and the switch/diode Q2 is opened. Specifically, in DCM, the electronic switch Q2 is opened (and remains opened during the interval T₃) when the current I_{L} reaches zero.

FIG. 6 shows in this respect an example of a typical control circuit 22 for the switching stage 26 of a buck converter 20. Specifically, in FIG. 6, the buck converter 20 comprises also a feedback circuit 24 configured to generate a feedback signal FB indicative of (and preferably proportional to) the output voltage Vₒᵤₜ and a control circuit 22 configured to generate the drive signal DRV₁ for the electronic switch Q1 and optionally the drive signal DRV₂ for the electronic switch Q2 (in case the electronic switch Q2 is not replaced with a diode) as a function of the feedback signal FB and a reference signal V_{ref} indicative of (and preferably proportional to) a requested value for the output voltage Vₒᵤₜ.

Specifically, in FIG. 6, the control circuit 22 comprises a PWM signal generator circuit 222 configured to generate a Pulse-Width Modulated (PWM) signal DRV as a function of the feedback signal FB and the reference signal V_{ref}, and a driver circuit 220 configured to generate the drive signal DRV₁ for the electronic switch Q1 and optionally the drive signal DRV₂ for the electronic switch Q2 as a function of the PWM signal DRV.

Generally, as shown in FIG. 7, the PWM signal DRV comprises a switch-on period T_{ON} where the signal is set to high and a switch-off period T_{OFF} where the signal is set to low. Generally, the switching period T_{SW} = T_{ON} + T_{OFF}, may be constant or variable.

FIG. 8 shows a possible implementation of the driver circuit 220. Specifically, in case the switching stage 26 comprises the electronic switch Q1 and a diode D, the driver circuit 220 may comprise a high-side driver circuit 2202 configured to generate the drive signal DRV₁ as a function of the PWM signal DRV. Specifically, in this case, the high-side driver circuit 2202 may receive at input a signal IN₁, which corresponds to the signal DRV, i.e., the logic level of the drive signal DRV₁ corresponds to the logic level of the PWM signal DRV, but the signal levels change in order to correctly drive the high side switch Q1, possibly also implementing a slew-rate control.

Conversely, in case the switching stage 26 comprises the electronic switch Q1 and the electronic switch Q2, the driver circuit 220 may comprise a high-side driver circuit 2202 configured to generate the drive signal DRV₁ as a function of a signal IN₁, a low-side driver circuit 2204 configured to generate the drive signal DRV₂ as a function of a signal IN₂, and a driver control circuit 2200 configured to generate the signals IN₁ and IN₂ for the high-side driver circuit 2202 and low-side driver circuit 2204 as a function of the PWM signal DRV. Specifically, as shown in FIG. 7, the driver control circuit 2200 may be configured to monitor the rising and falling edged of the PWM signal DRV. In response to detecting a rising edge, the driver control circuit 2200 may set the signal IN₂/DRV₂ (e.g., immediately) to low and set the signal IN₁/DRV₁ (immediately or preferably after a dead-time DT₁) to high. Moreover, in response to detecting a falling edge, the driver control circuit 2200 may set the signal IN₁/DRV₁ (e.g., immediately) to low and set the signal IN₂/DRV₂ (immediately or preferably after a dead-time DT₂) to high.

As mentioned before, this driving scheme may be used when the switching stage 26 is driven in CCM. Conversely, in DCM, the electronic switch Q2 (when used) should be opened when the current flowing through the inductance L reaches zero during the switch-off period T_{OFF}. For example, for this purpose, the driver circuit 220 may also receive a so-called zero current signal ZC indicating whether the current I_{L} flowing through the inductance L reaches zero (at least during the interval T_{OFF}). Accordingly, in this case, the driver control circuit 2200 may be configured to monitor the rising and falling edged of the PWM signal DRV and the zero-current signal ZC. In response to detecting a rising edge, the driver control circuit 2200 may set the signal IN₁/DRV₁ (e.g., immediately) to high. In response to detecting a falling edge, the driver control circuit 2200 may set the signal IN₁/DRV₁ (e.g., immediately) to low and set the signal IN₂/DRV₂ (immediately or preferably after a dead-time DT₂) to high. Moreover, in response to detecting that the zero-current signal ZC indicates that the current flowing through the inductance L reaches zero during the switch-off period T_{OFF}, the driver control circuit 2200 may set the signal IN₂/DRV₂ (e.g., immediately) to low.

For example, as shown in FIG. 6, the zero-current signal ZC may be provided by a zero current detection (ZCD) circuit 224. For example, the zero current detection circuit 224 may be implemented with a comparator, so-called zero-current comparator, receiving at input a signal indicative of the current I_{L} flowing through the inductance L during the switch-off period T_{OFF}. Specifically, the zero-current comparator may be configured to determine whether the monitored signal falls below a given threshold (which is usually close to zero).

For example, as shown in FIG. 6, the switching stage 26 may comprise a current sensor 206 connected directly in series with the inductance L, wherein the current sensor 206 provides a signal CS indicative of (and preferably proportional to) the current I_{L} flowing through the inductance L. Alternatively, the current I_{L} flowing through the inductance L during the switch-off period T_{OFF} may be monitored via a current sensor 204 connected directly in series with the electronic switch Q2, wherein the current sensor 204 provides a signal CS_{Q2} indicative of (and preferably proportional to) the current flowing through the switch Q2, which corresponds to the current I_{L} flowing through the inductance L during the interval T_{OFF}. Accordingly, the zero-current comparator 224 may receive the signal CS or CS_{Q2}.

In order to generate the PWM signal DRV, the PWM generator (GEN) circuit 222 may use various solutions. Generally, these solutions have in common that, irrespective of whether CCM or DCM is used, the energy transfer may be regulated by varying the duty-cycle of the PWM signal DRV. For example, the PWM generator circuit 222 may be configured to directly vary the duty-cycle of the PWM signal DRV, e.g., increase the duty-cycle of the PWM signal DRV when the feedback signal FB is smaller than the reference signal V_{ref}, and decrease the duty-cycle of the PWM signal DRV when the feedback signal FB is greater than the reference signal V_{ref}. For example, for this purpose, the PWM generator circuit 222 comprise a Proportional-Integral-Derivative (PID) regulator configured to vary the duty-cycle of the PWM signal DRV as a function of the error, i.e., the difference, between the signals FB a V_{ref}.

Recently, time-based PID control circuits have been proposed. For example, such time-based PID control circuits are described in United States Patent Application Publication No. 2021/0226531 A1 or 2023/0163767 A1, which are incorporated herein by reference. For example, by virtue of the continuous-time digital nature of the time-based PWM controller, they combine the advantages of conventional analog and digital controllers. Basically, they operate with CMOS-level digital-like signals, but without adding any quantization error typically found in digital controllers. Deploying simple circuits such as ring oscillators, delay lines, and flip-flops, time-based controllers eliminate the need for wide bandwidth error amplifiers, PWM blocks in analog controllers or high-resolution ADCs and digital PWM blocks in digital controllers. Using time as the processing variable, this new type of control provides an attractive solution for implementing wide-bandwidth high-switching frequency PWM-based converters, because it obviates the need for power and area hungry wide bandwidth amplifiers and high-speed comparators present in conventional controllers.

For example, FIG. 9 schematically shows an example of a time-based PWM signal generator 222 configured to generate a PWM signal DRV as a function of a feedback signal FB indicative of the output voltage Vₒᵤₜ generated by the switching stage 26 of the buck converter and a reference voltage V_{REF}. Specifically, in the example considered, the PWM signal generator 222 comprises: a first voltage-controlled oscillator (VCO) 2220 configured to generate a first clock signal CLK1 as a function of the feedback signal FB; an analog differentiator 2222 configured to generate a signal indicative of (and preferably proportional to) the derivative of the feedback signal FB, e.g., implemented with a capacitor C_{D} and a resistor R_{D} connected in series between the feedback signal FB and a reference voltage, e.g., ground (which may correspond e.g., to the negative input terminal 200b or the negative output terminal 202b), wherein the intermediate node between the capacitor C_{D} and the resistor R_{D} corresponds to the signal indicative of the derivative of the feedback signal FB; a first delay line 2224 having a delay as a function of the feedback signal FB; a second delay line 2226 having a delay as a function of the signal indicative of the derivative of the feedback signal FB; wherein the first and second delay lines are connected in cascade and generate a delayed first clock signal CLK1’; a second voltage-controlled oscillator 2228 configured to generate a second clock signal CLK2 as a function of the reference voltage V_{REF}; and a phase detector (PD) circuit 2230 configured to generate the PWM signal DRV, wherein the duty cycle of the PWM signal DRV is determined as a function of the phase difference Φ between the clock signal CLK2 and the delayed clock signal CLK1’.

Delay lines having a programmable delay as a function of a voltage or current signal are well known in the art. For example, in this context may be cited United States Patent Nos. 5,650,739 A or 7,696,799 B2, which are incorporated herein by reference.

For example, as shown in FIG. 10, the phase detector circuit 2230 may be configured to set the signal DRV to high when the second clock signal CLK2 is high and the delayed first clock signal CLK1’ is low. For example, the phase detector 2230 may be implemented with one or more logic gates and/or one or more latches.

In the example considered, the second voltage-controlled oscillator 2228 provides thus a clock signal CLK2 having a given (fixed or settable) frequency as a function of the reference voltage V_{REF}. Conversely, the first voltage-controlled oscillator 2220 varies the frequency of the first clock signal CLK1 until the feedback signal FB corresponds to the reference voltage V_{REF}, and in this steady condition the frequency of the first clock signal CLK1 corresponds to the frequency of the second clock signal CLK2, but the clock signals are phase shifted by a given phase Φ_{I}. The first oscillator 2220 implements thus a regulator with I component of the phase Φ_{I}. Conversely, the first delay line 2224 and the second delay line 2226 introduce an additional phase Φ_{P} being proportional to the feedback signal FB and an additional phase Φ_{D} being proportional to the derivative of the feedback signal FB, i.e., the total phase shift Φ corresponds to: Φ = Φ_{I} + Φ_{P} + Φ_{D}. As shown in FIG. 10, the phase shift Φ is proportional to (and preferably corresponds to) the switch on duration T_{ON} (e.g., T_{ON} = T_{SW}(Φ/2π)), i.e., the signal DRV is a PWM signal wherein the switch-on duration T_{ON}/the duty cycle is varied via a time-based control (with PID regulation) of the phase shift Φ as a function of the feedback signal FB and the reference voltage V_{REF}. Accordingly, the phase detector 2230 may also perform other operations, such as a down-scaling operation of the frequency of the clock signals CLK1/CLK2, and it is only relevant that the phase detector 2230 is configured to generate a PWM signal DRV, wherein the switch-on duration T_{ON} of the signal DRV is determined as a function of the phase shift Φ.

FIG. 11 shows a second example of a time-based PWM signal generator 222. Specifically, in the example considered, the following modifications have been performed, which also may be used separately: the voltage-controlled oscillators 2220 and/or delay lines 2224 and 2226 have been replaced with current-controlled oscillators and/or delay lines; the delay lines 2224 and 2226 have been combined into the same delay line 2234; a differential approach is used, wherein the oscillators 2220/2228 and/or the delay lines 2234/2235 are driven with differential signal.

Specifically, in the example considered, again a feedback circuit 24 is used to determine a feedback signal FB proportional to the output voltage Vₒᵤₜ. For example, the feedback circuit 24 may be implemented with a voltage divider 24 comprising two or more resistors R_{FB1} and R_{FB2} connected in series between the terminals 202a and 202b, wherein the voltage V_{FB} at one of the resistors, e.g., resistor R_{FB2}, corresponds to the feedback signal FB.

In the example considered, the feedback signal FB and the reference voltage V_{REF} are provided to a first differential transconductor 2236, such as a differential operational transconductance amplifier (OTA). For example, the differential transconductor 2236 may provide a first current i_{I+} = i_{I0} + i_{I}/2, and a second current i_{I-} = i_{I0} - i_{I}/2. Specifically, in a differential transconductor 2236 the difference i_{I} = i_{I+} – i_{I-} between the currents i_{I+} and i_{I-} is proportional to the difference between the respective input voltages, i.e., the reference voltage V_{REF} and the feedback voltage V_{FB}, i.e., i_{I} = G_{mI}(V_{REF} - V_{FB}). Accordingly, the differential transconductor 2236 may provide a common mode current i_{I0}.

In the example considered, the current i_{I-} is provided to the current-controlled oscillator 2220 and the current i_{I+} is provided to the current-controlled oscillator 2228, such as two ring-oscillators. Accordingly, the oscillator 2220 generates a clock signal CLK1 having a frequency proportional to the current i_{I-} and the oscillator 2228 generates a clock signal CLK2 having a frequency proportional to the current i_{I+}. Thus, when the feedback voltage V_{FB} corresponds to the reference voltage V_{REF}, both oscillators are supplied with the current i_{I0}, which thus determines the steady state frequency of the clock signals CLK1 and CLK2.

Similarly, the feedback signal FB and the reference voltage V_{REF} are provided to a second differential transconductor 2238, such as a differential operational transconductance amplifier. For example, the differential transconductor 2238 may provide a first current i_{P+} = i_{P0} + i_{P}/2, and a second current i_{P-} = i_{P0} – i_{P}/2. Specifically, in the differential transconductor 2238 the difference i_{P} = i_{P+} – i_{P-} between the currents i_{P+} and i_{P-} is proportional to the difference between the respective input voltages, i.e., the reference voltage V_{REF} and the feedback voltage V_{FB}, i.e., i_{P} = G_{mP}(V_{REF} - V_{FB}).

In the example considered, again an analog differentiator 2222 is used to generate a signal V_{D} proportional to the derivative of the output voltage Vₒᵤₜ. For example, the analog differentiator 2222 may be implemented with a capacitor C_{D} and a resistor R_{D} connected between the output voltage Vₒᵤₜ or the feedback signal FB, and a reference voltage, such as ground or preferably a reference voltage V_{BIAS}. For example, when connecting the resistor R_{D} to the reference voltage V_{BIAS} the derivative signal V_{D} has an offset of V_{BIAS} to which the derivative component of the output voltage Vₒᵤₜ is added. The reference voltage V_{BIAS} may also correspond to the reference voltage V_{REF}.

In the example considered, the derivative signal V_{D}, e.g., the voltage at the intermediate node between the capacitor C_{D} and the resistor R_{D}, and the reference voltage V_{BIAS} are provided to a third differential transconductor 2240, such as a differential operational transconductance amplifier. For example, the differential transconductor 2240 may provide a first current i_{D+} = i_{D0} + i_{D}/2, and a second current i_{D-} = i_{D0} – i_{D}/2. Specifically, in the differential transconductor 2240 the difference i_{D} = i_{D+} – i_{D-} between the currents i_{D+} and i_{D-} is proportional to the difference between the respective input voltages, i.e., the reference voltage V_{REF} and the derivative signal V_{D}, i.e., i_{P} = G_{mD}(V_{BIAS} – V_{D}).

Similar to the description of FIG. 9, the currents i_{P+} and i_{D+} and/or the currents i_{P-} and i_{D-} may be provided to respective delay lines, such as: two delay lines connected in series (essentially corresponding to the delay lines 2224 and 2226) may be configured to generate a delayed version CLK1’ of the clock signal CLK1 as a function of the currents i_{P-} and i_{D-}, respectively; and/or two delay lines connected in series may be configured to generate a delayed version CLK2’ of the clock signal CLK2 as a function of the currents i_{P+} and i_{D+}.

Generally, the term "and/or" highlights the possibility that these delay lines may be provided for each clock signal (as shown in FIG. 11 for a differential approach) or only for a single clock signal (as shown in FIG. 9).

Conversely, in the example considered, the currents i_{P+} and i_{D+} are provided to a first summation node, which thus provides a current I_{R} = i_{P+} + i_{D+}, and/or the currents i_{P-} and i_{D-} are provided to a second summation node, which thus provides a current I_{F} = i_{P-} + i_{D-}. In the example considered, the current I_{R} is provided to the delay line 2235 and/or the current I_{F} is provided to the delay line 2234, such as a sequence of delay stages having a delay as a function of a respective supply current, i.e., the currents I_{F} and I_{R}.

Accordingly, in the example considered and as also shown in FIG. 12, the delay stage 2235 generates a delayed clock signal CLK2’ having a delay t_{d2} with respect to the clock signal CLK2 and/or the delay stage 2234 generates a delayed clock signal CLK1’ having a delay t_{d1} with respect to the clock signal CLK1.

In the example considered, the delayed clock signals CLK2’ and CLK1’ are then provided to a phase detector 2230, which e.g., is configured to set the signal DRV to a first logic level (e.g., high) at the rising edge of CLK2’, and set the signal DRV to a second logic level (e.g., low) at the rising edge of the signal CLK1’.

Thus, in the example considered, in steady state, the feedback signal V_{FB} corresponds to the reference voltage V_{REF}, and by connecting the analog differentiator to the reference voltage V_{BIAS}, the signal V_{D} corresponds to the reference voltage V_{BIAS}. Thus, in the steady state, the differential currents i_{D}, i_{P} and i_{I} are zero, and (when using a differential approach) the delay t_{d1} of the delay line 2234 corresponds to the delay t_{d2} of the delay line 2235. Moreover, the oscillators 2220 and 2228 provide two clock signals CLK1 and CLK2 having the same frequency and a phase-shift Φ_{I}. Due to the fact, that the delay lines 2234 and 2235 introduce the same delay t_{d1} = t_{d2}, the phase shift Φ between the delayed clock signals CLK1’ and CLK2’ corresponds to Φ_{I}, e.g., the duration T_{ON} corresponds to (or is proportional to) the delay Φ_{I}, e.g., T_{ON} = T_{SW}(Φ_{I}/2π). Accordingly, the duty cycle D = T_{ON}/T_{SW} of the signal DRV corresponds thus to Φ_{I}/2π. For example, in a buck converter, the duty cycle may be determined (approximately) as a function of the input and output voltage, i.e., D = Φ_{I}/2π = Vₒᵤₜ/Vᵢₙ.

As mentioned before, also only one of the delay lines 2234 or 2235 could be used or one of the delay lines could introduce a constant delay, i.e., one of the delays t_{d1} or t_{d2} could be zero or at least constant. In fact, in this case, the oscillators 2220 and 2228 would generate clock signals having a phase shift Φ_{I} which also compensate the constant delay t_{d1} or t_{d2}. Thus, in general, one or more first delay lines 2234 are connected between the oscillator 2220 and the phase detector 2230 and/or one or more second delay lines 2235 are connected between the oscillator 2228 and the phase detector 2230, wherein the one or more first delay lines 2234 and/or the one or more second delay lines 2235 are driven via the currents i_{P} and i_{D}.

In many applications a high-current capability is required and at the same time high efficiency is mandatory in the whole range of load current. Some of these applications are digital intensive ASICs, GPUs, CPUs, NPUs and AI processors. In addition, such applications may demand a hyper-fast load-step transient response on the supply rails, such as below 30mV with a load-step current of 250A/µs. These dynamic specifications may usually just be met by increasing the switching frequency of the DC-DC converters providing such rails (e.g., up to 100MHz), in order to reach very high bandwidth and ensure a fast reaction to load step transient. An added benefit of high-frequency operation is the miniaturization of the passive components constituting the DC-DC converter (i.e., coil as well as input and output capacitors), eventually allowing to integrate the passive components on-chip or in-package. The DC-DC converters in this field are usually identified as high-frequency-voltage-regulators (HFVR) and/or fully-integrated-voltage-regulators (FIVR). To cope with the aforementioned specifications, the DC-DC converters are typically multiphase electronic converters, allowing to obtain a fine-grained regulated supply (i.e., different phases are enabled according to the load to maximize the efficiency). To fully exploit the benefit of a multiphase DC-DC, the phases of the converter must be operated to be interleaved. For example, usually the N phases are operated with a phase shift of 360°/N, which permits to reduce the voltages and current ripples (both at the input and the output).

Accordingly, it would be useful to also apply the time-based PID control to multi-phase electronic converters, such as multiphase buck converters. Reference is made to Kim, et al., "A 4-Phase 30–70 MHz Switching Frequency Buck Converter Using a Time-Based Compensator," in IEEE Journal of Solid-State Circuits, vol. 50, no. 12, pp. 2814-2824, Dec. 2015 (incorporated by reference) which discloses a time-based control circuit for a multiphase (N = 4) buck converter.

Specifically, as shown in FIG. 13, the multiphase buck converter comprises a plurality of phases or switching stages 26, such as switching stages 26₁to 26₄for four phases. Specifically, each switching stage 26 comprises the electronic switch Q1, the electronic switch Q2 or diode D, and the inductance L shown in FIGS. 2 and 6. Specifically, the inductance L of each switching stage is connected between the switching node Lx of the respective switching stage (i.e., the intermediate node between the respective switches Q1 and Q2/D) and the (common) output terminal 202a. Each switching stage 26 may also comprise a respective capacitance Cₒᵤₜ or one or more (shared) capacitances may be connected between the output terminals 202a and 202b. Accordingly, by driving the switching stages 26, each switching stage 26 may provide a current I_{L} used to charge the one or more capacitances Cₒᵤₜ.

Accordingly, the control circuit of the multiphase buck converter comprises for each phase a respective phase control circuit 406, such as phase control circuits 406₁ to 406₄ for four phases. Specifically, each phase control circuit 406 comprises a driver circuit 220 configured to generate the drive signals DRV₁ and optionally the drive signal DRV₂ for the respective switching circuit 26 as a function of a respective PWM signal DRV. Reference is made to the description of FIGS. 4, 5, 7 and 8 for possible implementations of CCM or DCM driver circuits 220.

Accordingly, in the example considered, the control circuit of the multiphase buck converter should be configured to generate the PWM signals DRV of the phase control circuit 406. Specifically, according to the article by Kim et al., a time-based PID regulator 400 may be used to generate a first clock signal F_{C} and a second clock signal R_{C} as a function of a feedback signal indicative of the output voltage Vₒᵤₜ. For example, the clock signal F_{C} may correspond to the clock signal CLK1’ of FIGS. 9 or 11, and the clock signal R_{C} may correspond to the clock signal CLK2’ of FIGS. 9 or 11. Accordingly, the time-based PID regulator 400 may comprise the oscillators 2220 and 2228, and one or more delay lines 2224, 2226, 2234 and 2235 (see also the description of FIGS. 9 and 11).

Specifically, in the arrangement of Kim, et al., the clock signals F_{C} and R_{C} are provided to respective multiphase generators (MPG), which generate a plurality of phase-shifted clock signals, i.e., a multiphase generator 402 generates for each phase a respective clock signal F, e.g., clock signals F₁ to F₄ for four phases, as a function of the clock signal F_{C} and a multiphase generator 404 generates for each phase a respective clock signal R, e.g., clock signals R₁ to R₄ for four phases, as a function of the clock signal R_{C}. Moreover, in the arrangement of Kim et al., each phase control circuit 406 comprises a phase detector 2230 which receives a respective pair of clock signals F and R, i.e., the phase detector 2230 of the phase control circuit 406₁receives the clock signals F₁ and R₁, the phase detector 2230 of the phase control circuit 406₂receives the clock signals F₂ and R₂, etc. Accordingly, in this way each phase is driven with a respective PWM signal DRV, wherein the various PWM signals DRV have the same period T_{SW} and duty cycle D, but are phase shifted.

For example, as shown in FIGS. 14 and 15, in the arrangement of Kim et al., the multiphase generator 402 is implemented with a counter with one-hot encoding. For example, the multiphase generator 402 may comprise three D-type flip-flops 4020, 4022, 4024, which receive the clock signal R_{C} at a respective clock input. Moreover, the flip-flop 4022 receives at input the output signal of the flip-flop 4020 and the flip-flop 4024 receives at input the output signal of the flip-flop 4022. Moreover, a logic NOR gate 4026 generates the input signal of the flip-flop 4020 by combining the output signals of the flip-flops 4020, 4022 and 4022. Specifically, in the arrangement of Kim, et al., the clock signals R1, R2, R3, R4 for the phases control circuits 406₁, 406₂, 406₃, 406₄, correspond to the input signal of the flip-flop 4020 and the output signals of the flip-flops 4020, 4022 and 4024, respectively.

The arrangement of Kim, et al., is noted as having various drawbacks, which limit an industrial application of the solution.

Considering the foregoing, there is a need to provide a time-based control circuit for a multiphase electronic converter, such as a multiphase buck converter.

### SUMMARY

One or more embodiments concern a time-based control circuit for a multiphase electronic converter, such as a multiphase buck converter.

Embodiments moreover concern a related integrated circuit, multiphase electronic converter and method of operating a multiphase electronic converter

As mentioned before, various embodiments of the present disclosure relate to a control circuit for a multiphase electronic converter comprising a plurality of N switching stages. For example, the control circuit may be integrated in an integrated circuit.

Specifically, in various embodiments, the control circuit comprises a first regulator circuit comprising a first output terminal for providing a first clock signal and a second output terminal for providing a second clock signal. Specifically, for this purpose, the output of a first oscillator is coupled to the first output terminal of the first regulator circuit and the output of a second oscillator is coupled to the second output terminal of the first regulator circuit. Specifically, the first regulator circuit is configured to vary the switching frequency of the first oscillator and/or the second oscillator as a function of a feedback signal indicative of an output voltage provided by the multiphase electronic converter. For example, the first regulator circuit may vary the switching frequency of the first oscillator as a function of a feedback signal and the switching frequency of the second oscillator may be set via a reference signal. Alternatively, the feedback signal and the reference signal may be provided to a differential transconductor configured to drive the first oscillator and the second oscillator.

Moreover, in various embodiments, the control circuit comprises a phase shift circuit configured to generate for each switching stage a respective control clock signal and a respective reference clock signal, wherein each control clock signal has the switching frequency of the first clock signal, and wherein each reference clock signal has the switching frequency of the second clock signal and is phase shifted with respect to the second clock signal by a respective phase shift.

Moreover, in various embodiments, the control circuit comprises for each switching circuit a respective phase control circuit, wherein each phase control circuit comprises a driver circuit configured to generate one or more drive signals for a respective switching stage as a function of a respective Pulse-Width Modulated (PWM) signal.

According to a first aspect of the present disclosure, each phase control circuit comprises a current balancing circuit. Specifically, in various embodiments, the current balancing circuit comprises a first input terminal for receiving a respective control clock signal from the phase shift circuit, a second input terminal for receiving a respective reference clock signal from the phase shift circuit and a third input terminal for receiving a signal indicative of a current provided by the respective switching stage.

Moreover, the current balancing circuit comprises a phase detector comprising a first input terminal connected via one or more delay lines to the first input terminal of the current balancing circuit and a second input terminal coupled to the second input terminal of the current balancing circuit, wherein the phase detector provides the PWM signal to the driver circuit of the respective phase control circuit.

Specifically, in various embodiments, the current balancing circuit comprises a second regulator circuit configured to vary the delay introduced by the one or more delay lines in order to balance the currents provided by the switching stages of the multiphase electronic converter. For example, the second regulator circuit may be configured to vary the delay introduced by the one or more delay lines in order to regulate the average value of the currents provided by the switching stages to a requested value. For example, the requested value may correspond to the average value of the current provided by a reference switching stage of the switching stages or the average value of the currents provided by a plurality of the switching stages.

Accordingly, in various embodiments, the first regulator circuit may implement just the integral component of a time-based regulator configured to regulate the output voltage of the electronic converter. However, the first regulator circuit may also implement a proportional and/or derivative component. In this case, the first regulator circuit may also comprise one or more first delay lines connected between the output of the first oscillator and the first output terminal for providing the first clock signal and/or one or more second delay lines connected between the output of the second oscillator and the second output terminal for providing the second clock signal. In this case, the first regulator circuit may be configured to vary the delay introduced by the one or more first delay lines and/or the one or more second delay lines as a function of the feedback signal indicative of the output voltage provided by the multiphase electronic converter and/or a further feedback signal indicative of the derivative of the output voltage provided by the multiphase electronic converter. For example, the feedback signal, the further feedback signal and one or more reference signals may be provided to two differential transconductors configured to drive the one or more first delay lines and/or the one or more second delay lines.

Alternatively, the proportional and/or derivative components of the output voltage regulation may be implemented in a third regulator circuit. Specifically, in various embodiments, the third regulator circuit is configured to vary the delay introduced by the one or more delay lines of each current balancing circuit as a function of the feedback signal indicative of the output voltage provided by the multiphase electronic converter and/or a further feedback signal indicative of the derivative of the output voltage provided by the multiphase electronic converter.

For example, in various embodiments, the one or more delay lines of the current balancing circuits are current controlled delay lines, wherein the second regulator circuit is configured to provide a respective first current and the third regulator circuit is configured to provide a respective second current to the one or more delay lines of each current balancing circuit. In various embodiments, the second input terminal of the phase detector may be connected via one or more further delay lines to the second input terminal of the current balancing circuit, wherein the third regulator circuit may provide a respective third current to the one or more further delay lines of each current balancing circuit.

For example, in various embodiments, the one or more delay lines may comprise a delay line configured to receive the sum of the respective first current and the respective second current. Similarly, the one or more further delay lines may comprise a delay line configured to receive the sum of the respective third current and a bias current. For example, in this case, the delay lines may be used to implement contemporaneously the phase shift used for the proportional and/or derivative output voltage regulation and for the current balancing operation. However, the proportional and/or derivative output voltage regulation and the current balancing operation may also be implemented with separate delay lines of the current balancing circuit.

In various embodiments, in order to generate the second current and the third current, the third regulator circuit may comprise a first differential transconductor configured to receive the feedback signal and a first reference signal, and a second differential transconductor configured to receive the further feedback signal and a second reference signal. In this case, the second current may correspond to the sum of a first current provided by the first differential transconductor and a first current provided by the second differential transconductor, and the third current may correspond to the sum of a second current provided by the first differential transconductor and a second current provided by the second differential transconductor.

According to a second aspect of the present disclosure, the phase shift circuit comprises N delay lines connected in cascade, wherein a first delay line of the N delay lines is configured to receive the second clock signal and the reference clock signals correspond to the input signals of the N delay lines. Moreover, the phase shift circuit comprises a multiplexer configured to select an output signal of the N delay lines, and a fourth regulator circuit configured to vary the delay introduced by each of the N delay lines, such that the rising edges of the signal provided by the multiplexer are aligned with the rising edges of the second clock signal, preferably with a phase shift of 2π.

In various embodiments, the phase shift circuit comprises additional N-1 delay lines connected in cascade, wherein a first delay line of the N-1 delay lines is configured to receive the first clock signal and the control clock signals correspond to the input signals of the N-1 delay lines and the output signal of the last delay line of the N-1 delay lines. In this case, the fourth regulator circuit is configured to set the delay introduced by each of the N-1 delay lines to the delay introduced by each of the N delay lines.

### BRIEF DESCRIPTION OF THE DRAWINGS

The embodiments of the present disclosure will now be described with reference to the annexed plates of drawings, which are provided purely to way of non-limiting example and in which:

The features and advantages of the present invention will become apparent from the following detailed description of practical embodiments thereof, shown by way of non-limiting example in the accompanying drawings, in which:

FIG. 1 shows a typical application of an electronic converter;

FIG. 2 shows an example of a buck converter;

FIG. 3 shows exemplary waveforms a) to e) of the buck converter of FIG. 2;

FIG. 4 shows exemplary waveforms when the buck converter is operated in CCM;

FIG. 5 shows exemplary waveforms when the buck converter is operated in DCM;

FIG. 6 shows an example of a control circuit for a single-stage buck converter;

FIG. 7 shows an example of the generation of the drive signals for the electronic switches of a buck converter as a function of a PWM signal;

FIG. 8 shows an example of a driver circuit configured to generate the drive signals for the electronic switches of a buck converter as a function of a PWM signal;

FIG. 9 shows a first example of a time-based PID regulator circuit configured to generate a PWM signal as a function of a feedback signal of the buck converter;

FIG. 10 shows exemplary clock signals generated by the time-based PID regulator circuit of FIG. 9;

FIG. 11 shows a second example of a time-based PID regulator circuit configured to generate a PWM signal as a function of a feedback signal of the buck converter;

FIG. 12 shows exemplary clock signals generated by the time-based PID regulator circuit of FIG. 11;

FIG. 13 shows an example of a time-based control circuit for a multiphase buck converter;

FIG. 14 shows an example of a phase shift circuit for the time-based control circuit of FIG. 13;

FIG. 15 shows exemplary clock signals generated by the phase shift circuit of FIG. 14;

FIG. 16 shows a first embodiment of a time-based control circuit for a multiphase electronic converter, such as a multiphase buck converter;

FIG. 17 shows an embodiment of a current balancing circuit for the control circuit of FIG. 16;

FIG. 18 shows a second embodiment of a time-based control circuit for a multiphase electronic converter, such as a multiphase buck converter;

FIG. 19 shows an embodiment of an integral regulator circuit for the control circuit of FIG. 18;

FIG. 20 shows an embodiment of a proportional and derivative regulator circuit for the control circuit of FIG. 18;

FIG. 21 shows a further embodiment of a current balancing circuit; and

FIG. 22 shows an embodiment of a phase shift circuit.

### DETAILED DESCRIPTION

In the ensuing description, various specific details are illustrated aimed at enabling an in-depth understanding of the embodiments. The embodiments may be provided without one or more of the specific details, or with other methods, components, materials, etc. In other cases, known structures, materials, or operations are not shown or described in detail so that various aspects of the embodiments will not be obscured.

Reference to "an embodiment" or "one embodiment" in the framework of this description is meant to indicate that a particular configuration, structure, or characteristic described in relation to the embodiment is comprised in at least one embodiment. Hence, phrases such as "in an embodiment", "in one embodiment", or the like that may be present in various points of this description do not necessarily refer to one and the same embodiment. Moreover, particular conformations, structures, or characteristics may be combined in any adequate way in one or more embodiments.

The references used herein are only provided for convenience and hence do not define the sphere of protection or the scope of the embodiments.

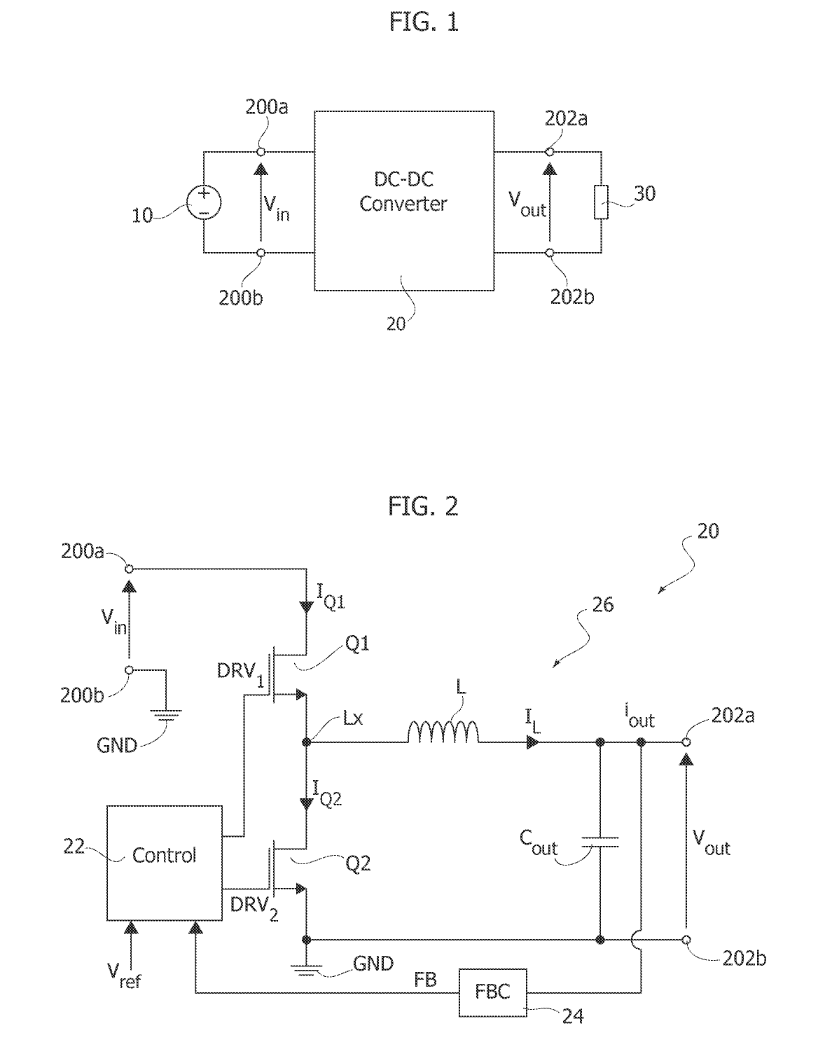

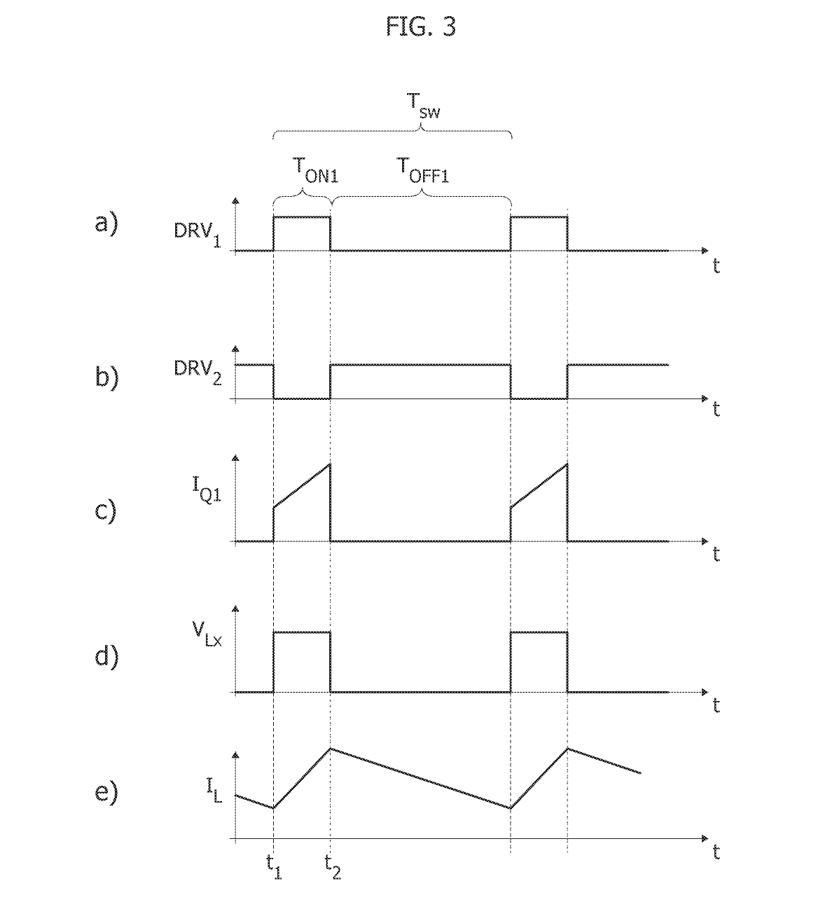

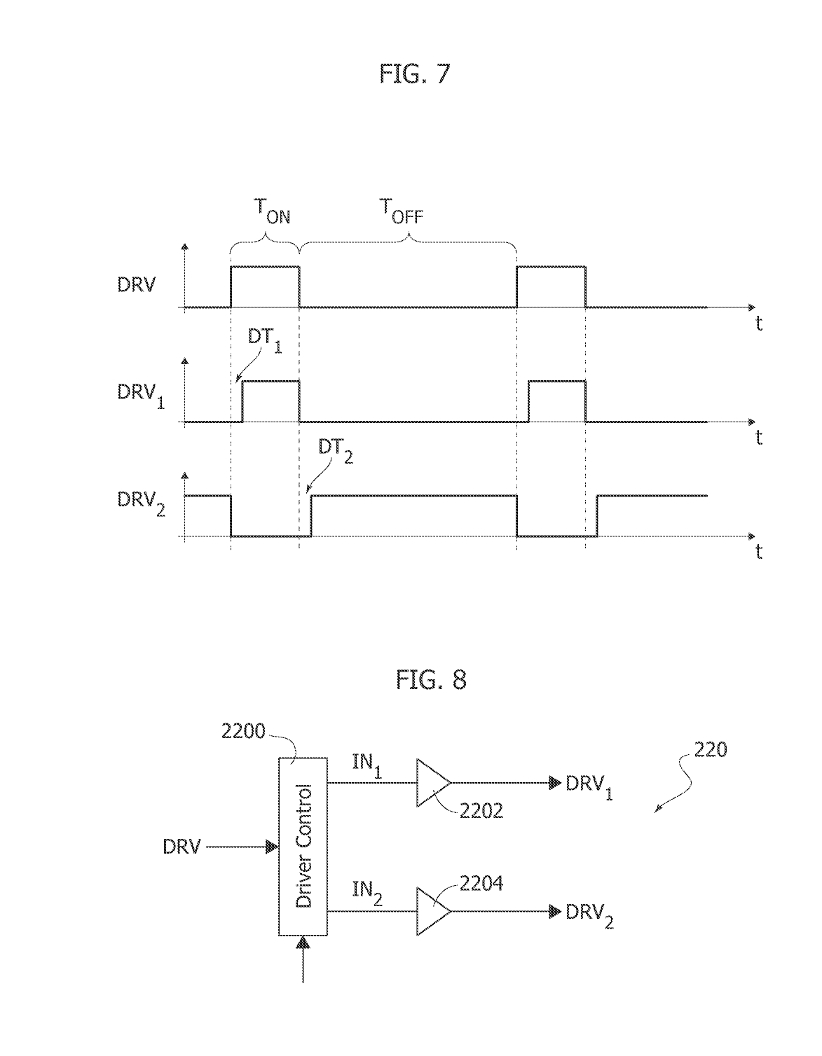

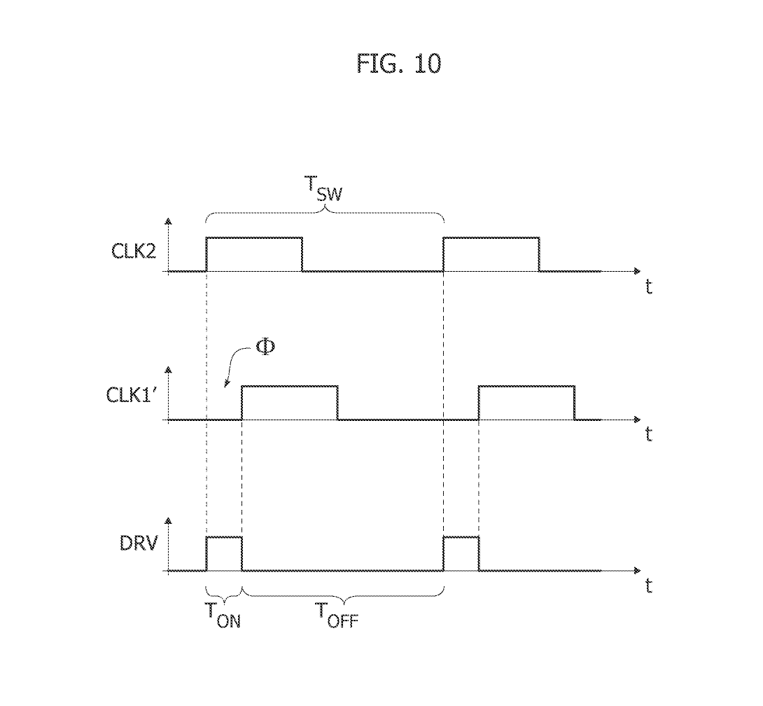

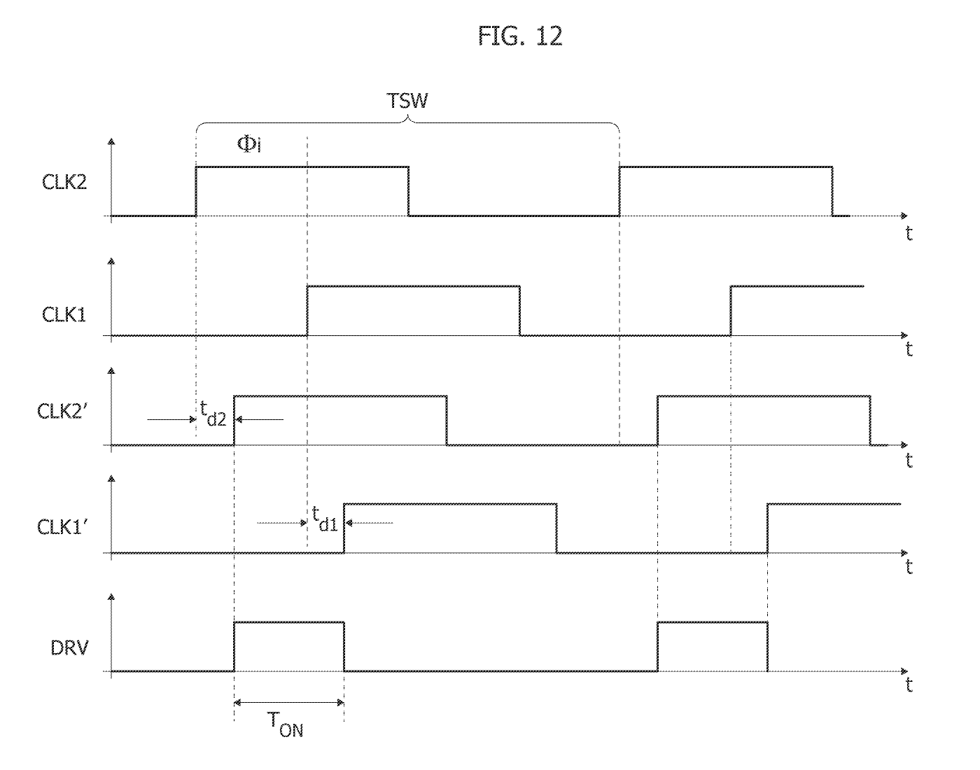

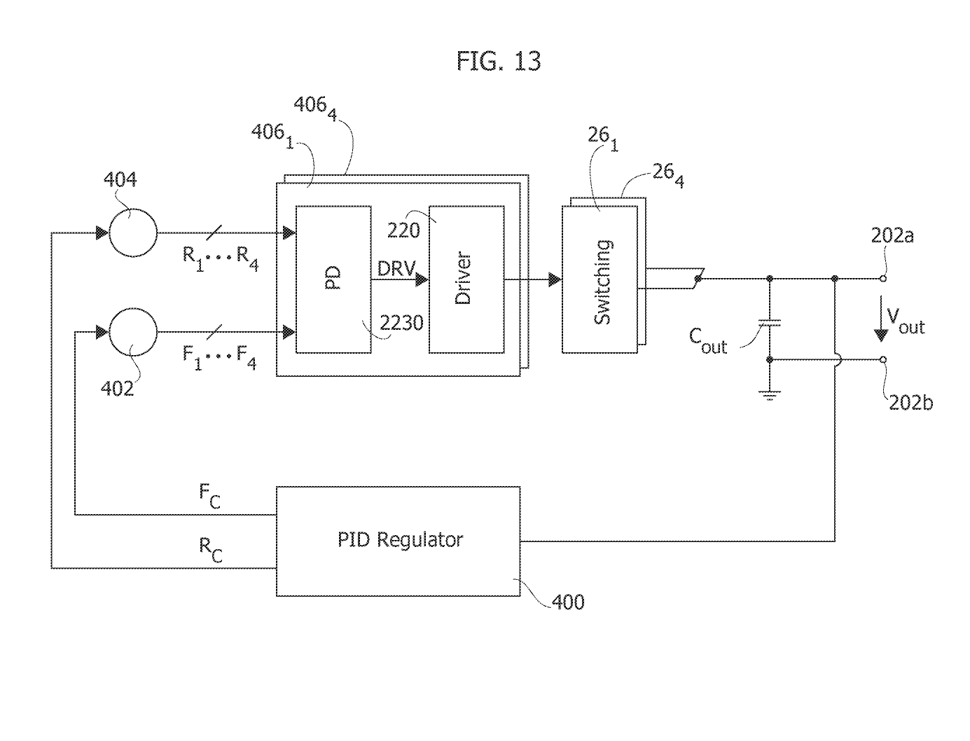

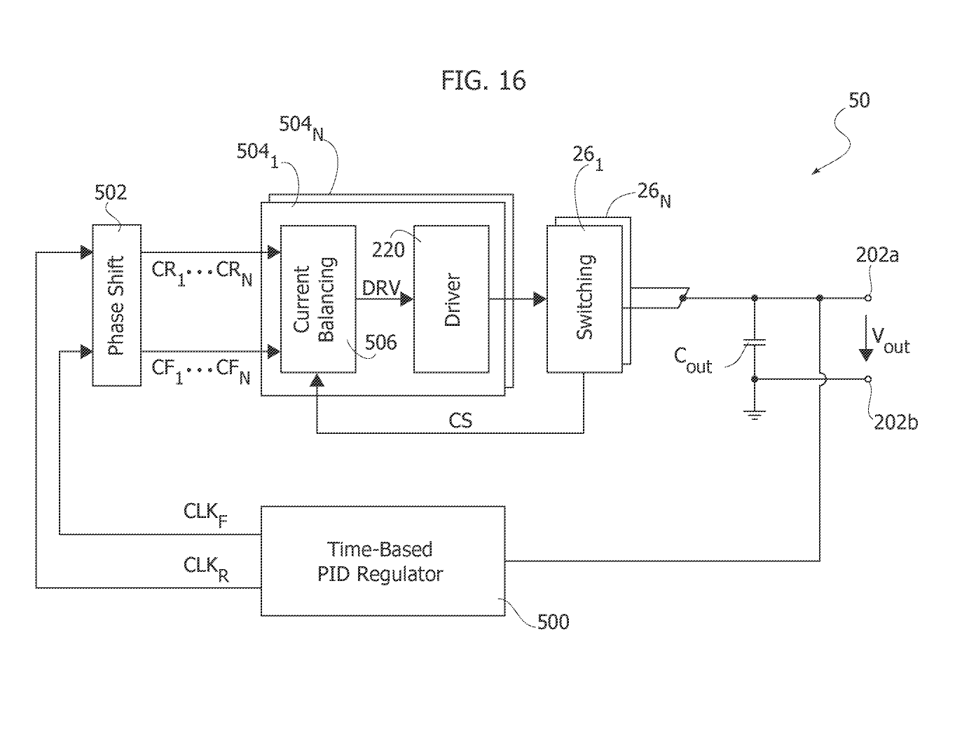

In FIGS. 16 to 22 described below, parts, elements or components that have already been described with reference to FIGS. 1 to 15 are designated by the same references used previously in these figures. The description of these elements has already been made and will not be repeated in what follows in order not to burden the present detailed description.

As mentioned before, various embodiments of the present disclosure relate to a time-based control device for a multiphase electronic converter, such as a multiphase buck converter.

Specifically, the inventors have observed that the arrangement of Kim, et al., has various drawbacks. First of all, the arrangement of Kim, et al., does not use a current-balancing mechanism. However, non-idealities and mismatches between phases are intrinsically unavoidable. For example, in each phase the signals may experience different delays (e.g., different paths, layout placement, etc.), the passive components may be subjected to tolerances and inherent diversities (this is especially true for FIVR), parasitic effects and the power-delivery-network (PDN) may hardly match for each phase, the voltage/current references may be different in each phase and the circuits in each phase may have offsets and exhibit different responses. For such a reason, without a current-balance mechanism, an equal duty-cycle command provided to each phase results in different current carried by the phases. In turn, efficiency is deeply degraded, reliability issues (e.g., protection triggering and/or damages) are faced and the whole converter performances are impacted (e.g., degraded stability and transient response). For this reason, in a multiphase converter an active mechanism is usually preferable to ensure that each phase provides an equal current (average) to the output.

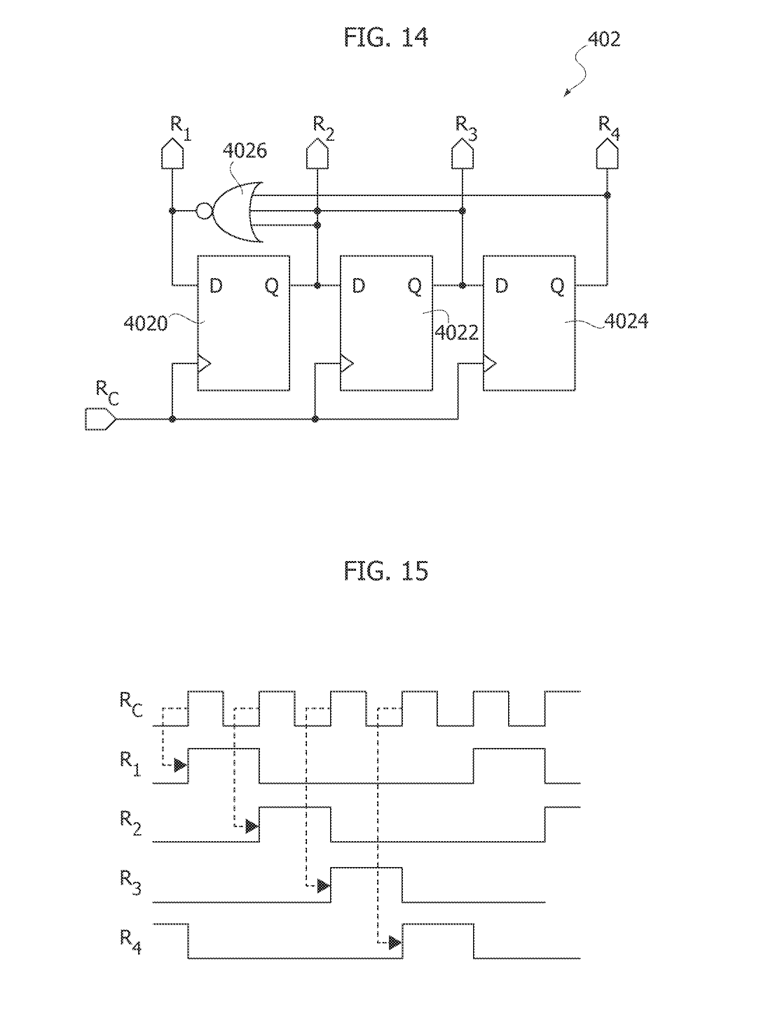

Moreover, various problems relate to the multiphase-generator (MPG) described with respect to FIGS. 14 and 15, which essentially implements a clock divider. For example, this implies that a fine-grained phase-shedding cannot be possible. In fact, being the MPG an integer divider, the MPG can only provide power of 2 number of signals, meaning that only power of 2 number of phases can be activated, thereby severely limiting the efficiency. This may represent a severe limitation in HFVR composed of a larger number of phases (e.g., with N=16, only 1, 2, 4, 8 and 16 phases can be operated). Moreover, the controller must operate at very high frequency. In fact, for a given switching frequency F_{SW} (of each phase), the time-based PID controller must operate at N ⋅ F_{SW}. For example, with N = 16 and F_{SW} = 100MHz, the time-based PID controller should operate at 1.6GHz, which poses severe design challenges and very high quiescent current consumption. This also implies that the converter is a system sampled at F_{SW}. Specifically, the same information from the time-based PID controller is provided to each phase and each phase is updated every 1/F_{SW}. This means that the benefits of a multiphase system are not leveraged. Conversely, in usual multiphase system, the system is refreshed with a new updated information every 1/(N ⋅ F_{SW}), thereby increasing the system response time. Finally, by providing the MPG after the time-based PID controller, the PID actions are delayed by the MPG, which further degrades the performance, limiting the bandwidth and compromising the stability.

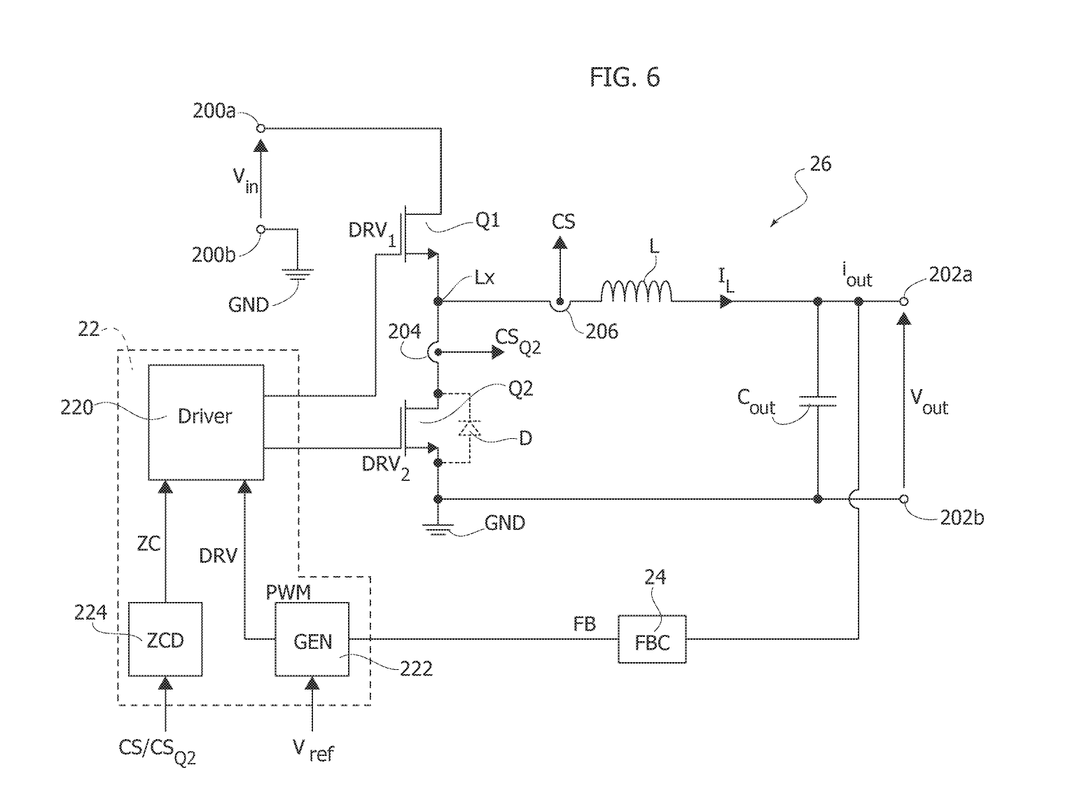

FIG. 16 shows an embodiment of a time-based control circuit 50 for a multiphase electronic converter according to the present disclosure. Specifically, as mentioned before, a multiphase electronic converter comprises a plurality of switching stages 26, such as switching stages 26₁to 26_{N}, where N corresponds to the number of phases. Reference is made to the previous description for possible embodiments of the switching stage 26. For example, in case of a multiphase buck converter, each switching stage 26 comprises the electronic switch Q1, the electronic switch Q2 or diode D, and the inductance L shown in FIGS. 2 and 6. Specifically, the inductance L of each switching stage is connected between the switching node Lx of the respective switching stage (i.e., the intermediate node between the respective switches Q1 and Q2/D) and the (common) output terminal 202a. Moreover, one or more capacitances Cₒᵤₜ are connected between the output terminals 202a and 202b. Accordingly, by driving the switching stages 26, each switching stage 26 may provide a current I_{L} used to charge the one or more capacitances Cₒᵤₜ. For example, the control circuit 50 may be provided as an integrated circuit. In various embodiments, the integrated circuit may also comprise the electronic switches Q1 and Q2, and possibly the inductances L of the switching stages 26. In various embodiments, the one or more capacitances Cₒᵤₜ are connected externally to pins or pads of the integrated circuit corresponding to the terminals 202a and 202b.

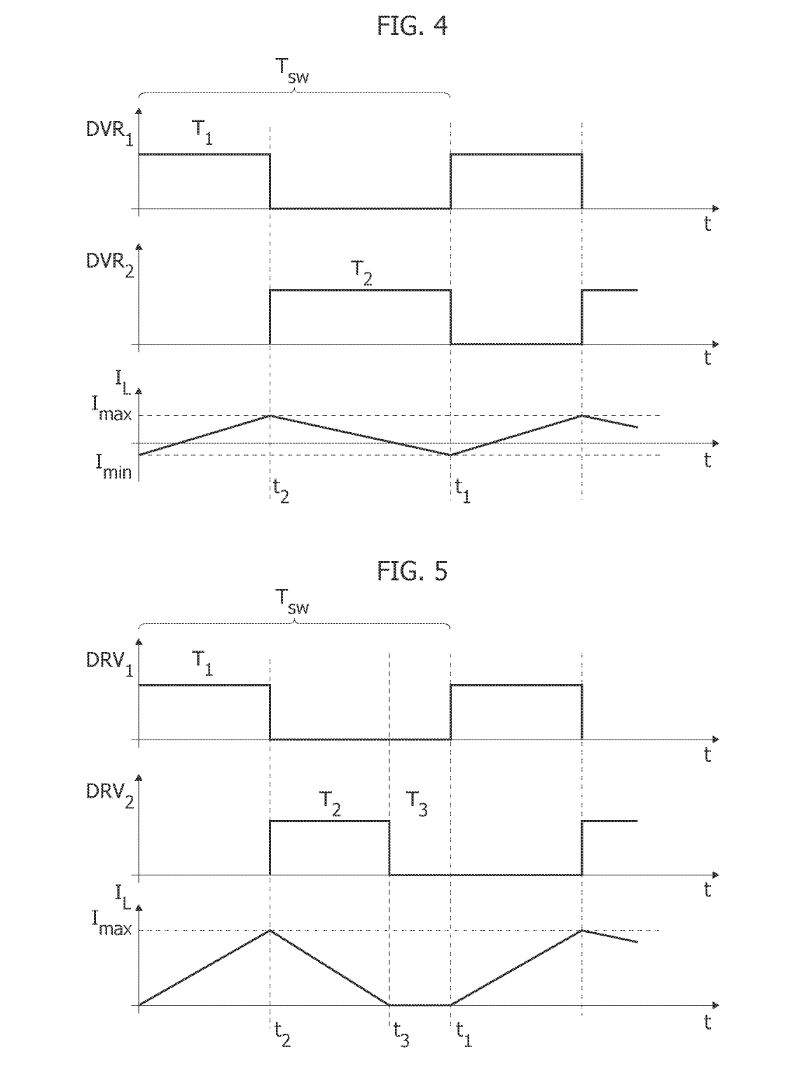

Specifically, in the embodiments considered, the control circuit 50 comprises for each phase a respective phase control circuit 504, such as phase control circuits 504₁to 504_{N}for N phases. Specifically, each phase control circuit 504 comprises a driver circuit 220 configured to generate the drive signals DRV₁ and optionally the drive signal DRV₂ for the respective switching circuit 26 as a function of a respective PWM signal DRV. Reference is made to the description of FIGS. 4, 5, 7 and 8 for possible implementations of CCM or DCM driver circuits 220.

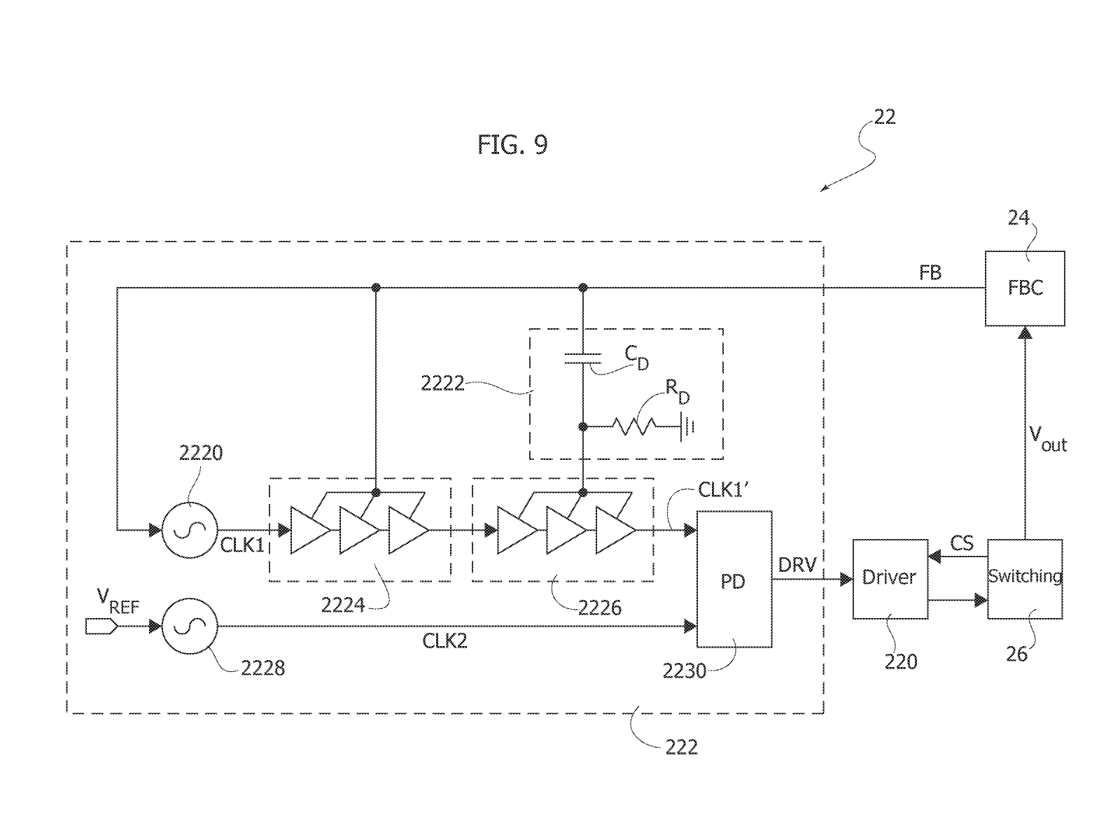

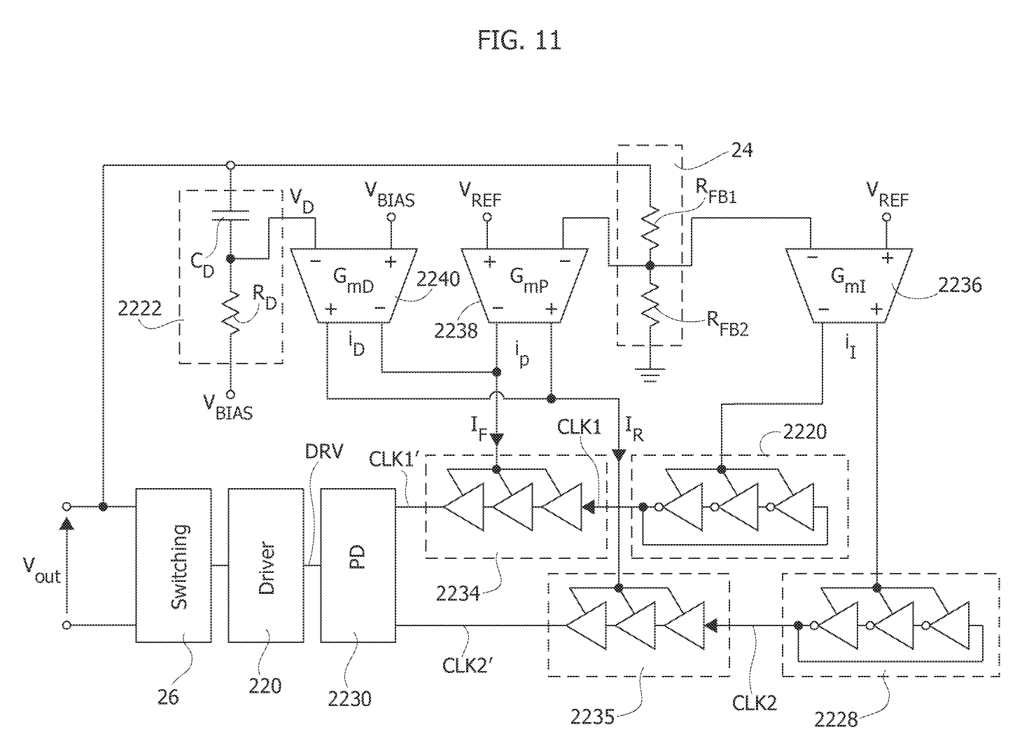

Accordingly, in the embodiment considered, the control circuit 50 is configured to generate the PWM signals DRV for the driver circuits 220 of the phase control circuits 504. Specifically, in the embodiment considered, a time-based PID regulator circuit 500 is configured to generate a first clock signal CLK_{F} and a second clock signal CLK_{R} as a function of a feedback signal indicative of the output voltage Vₒᵤₜ. For example, in various embodiments, the clock signal CLK_{F} may correspond to the clock signal CLK1’ of FIGS. 9 or 11, and the clock signal CLR_{R} may correspond to the clock signal CLK2 of FIG. 9 or the clock signal CLK2’ of FIG. 11.

For example, in various embodiments, the time-based PID regulator 500 may comprise the oscillators 2220 and 2228, wherein the regulator 500 is configured to vary the frequency of the oscillator 2220 and/or the oscillator 2228 as a function of a feedback signal indicative of the output voltage Vₒᵤₜ, e.g., provided by the feedback circuit 24. For example, in various embodiments, the regulator circuit 500 comprises the differential transconductor 2236, such as a differential operational transconductance amplifier.

Moreover, in various embodiments, one or more delay lines 2224, 2226, 2234 and 2235 (see also the description of FIGS. 9 and 11) are used to generate the signals CLK_{F} and CLK_{R} by delaying the clock signals CLK1 and/or CLK2 generated by the oscillators 2220 and 2228. Specifically, the regulator 500 is configured to vary the delay introduced by the delay lines 2224, 2226, 2234 and/or 2235 as a function of feedback signal indicative of the output voltage Vₒᵤₜ, e.g., provided by the feedback circuit 24, and a feedback signal V_{D} indicative of the derivative of the output voltage Vₒᵤₜ, e.g., provided by the feedback circuit 2222. Thus, in various embodiments, the regulator circuit 500 may also comprise the differential transconductors 2238 and 2240, such as differential operational transconductance amplifiers. In various embodiments, the regulator may also use just the integral component, the integral and proportional components, or the integral and derivative components.

In the embodiment considered, the clock signals CLK_{F} and CLK_{R} at the output of the regulator circuit 500 are provided to a phase shift circuit 502 configured to generate for each phase 26 a respective clock signal C_{F} as a function of the clock signal CLK_{F}, such as clock signals CF₁ to CF_{N}, and a respective clock signal C_{R} as a function of the clock signal CLK_{R}, such as clock signals CR₁ to CR_{N},

In the embodiment considered, each phase control circuit 504 comprises moreover a current balancing circuit 506 configured to generate the respective drive signal DRV as a function of a respective clock signals CF and CR, and a feedback signal CS indicative of the current I_{L} flowing through the inductance L of the respective switching stage 26. For example, the circuit 506 of the phase control circuit 504₁receives the clock signals CF₁ and CR₁, and a signal CS₁ indicative of the current flowing through the inductance L of the switching stage 26₁, the circuit 506 of the phase control circuit 504₂receives the clock signals CF₂ and CR₂, and a signal CS₂ indicative of the current flowing through the inductance L of the switching stage 26₂, etc.

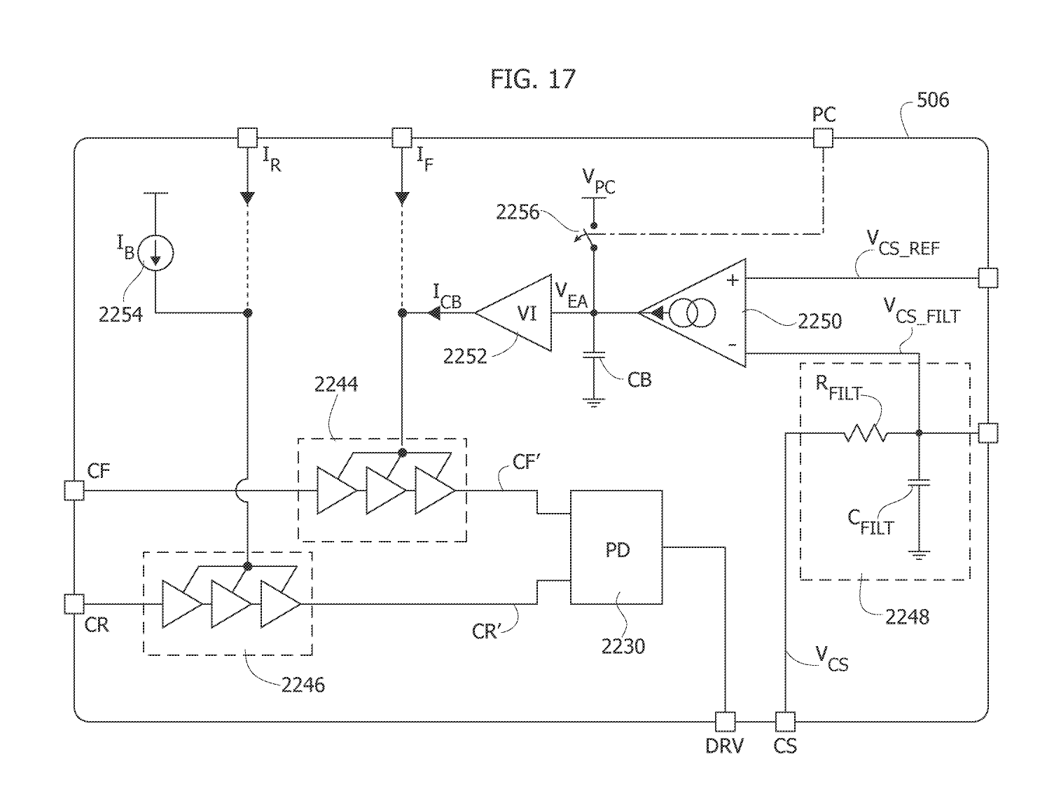

FIG. 17 shows an embodiment of the current balancing circuit 506. Specifically, in the embodiment considered, the current balancing circuit 506 comprises terminals for receiving the respective clock signals CF and CR, and the respective measurement signal CS. Moreover, the current balancing circuit 506 comprises a terminal for providing a respective PWM signal DRV.

Specifically, in the embodiment considered, the current balancing circuit 506 comprises a phase detector 2230 coupled to the terminals arranged to receive the clock signals CF and CR. However, compared to Kim et al., the current balancing circuit 506 comprises an additional delay line 2244. Substantially, in the embodiment considered, the current balancing circuit 506 is configured to vary the delay introduced by the delay line 2244 until the signal CS indicates that the average current provided by the respective switching stage 26 corresponds to a requested value V_{CS_REF}. For example, in case of a buck converter, the average current provided by a switching stage 26 corresponds to the average current flowing through the inductance L of the switching stage 26.

For example, in the embodiment considered, the current balancing circuit 506 receives as signal CS a voltage V_{CS} being proportional to the instantaneous value of the current provided by the switching stage, e.g., the instantaneous value of the current I_{L} flowing through the inductance L of the respective switching stage 26. In this case, the current balancing circuit 506 may comprise a low-pass filter circuit 2248 configured to generate a signal V_{CS_FILT} indicative of the average value of the voltage V_{CS}. For example, in the embodiment considered, the low-pass filter 2248 is implemented with an analog filter, e.g., comprising a resistance R_{FILT} and a capacitance C_{FILT}, wherein the voltage at the capacitance C_{FILT} corresponds to the signal V_{CS_FILT}. In general, the low pass filter 2248 is purely optional because the signal CS could already be indicative of the average value of the current provided by the switching stage 26. Moreover, also other low-pass filters may be used. In various embodiments, instead of regulating the average value of the current provided by the switching stage 26, the current balancing circuit 506 may also be configured to balance other values, such as the peak value of the currents I_{L}. For example, in this case, the filter circuit 2248 may be replaced with a peak detector.

In the embodiment considered, the signal V_{CS_FILT} and the requested value V_{CS_REF} are provided to an error amplifier. For example, in the embodiment considered, the error amplifier implements a regulator having an integral component. For example, in the embodiment considered, the error amplifier is an analog error amplifier comprising an operational amplifier 2250 receiving at a first input terminal, e.g., the positive/non-inverting terminal, the voltage

V_{CS_REF} and at a second input terminal, e.g., the negative/inverting terminal, the voltage V_{CS_FILT.} Moreover, a capacitance C_{B} is connected to the output of the operational amplifier 2250, thereby implementing the integral component. Accordingly, in the embodiment considered, the operational amplifier 2250 charges or discharges the capacitance C_{B} until the voltage V_{CS_FILT} corresponds to the voltage V_{CS_REF}. In various embodiments the error amplifier may also implement a proportional component.

Accordingly, in the embodiment considered, the current balancing circuit 506 varies the delay introduced by the delay line 2244 as a function of the signal provided by the error amplifier, e.g., the voltage V_{EA} at the capacitance C_{B}. For example, in various embodiments, the delay line 2244 is a current-controlled delay line. In this case, the current balancing circuit 506 may comprise also a voltage-to-current (VI) conversion circuit 2252 configured to generate a current I_{CB} based on the voltage V_{EA} at the capacitance C_{B}, wherein the current I_{CB} is provided to the delay line 2244.

Accordingly, in the embodiment considered, the delay introduced by the delay line 2244 is varied until the signal V_{CS_FILT} corresponds to the requested value V_{CS_REF}. Accordingly, in order to implement a current balancing operation, the requested value V_{CS_REF} may correspond to the value V_{CS_FILT} of one of the current balancing circuits 506, e.g., of the current balancing circuit 506 of the first phase control circuit 504₁. However, the requested value V_{CS_REF} may also correspond to the average value of the values V_{CS_FILT} of all (active) current balancing circuits 506. However, also other operations may be used to obtain the requested value V_{CS_REF}, such as an average value of the values V_{CS_FILT} of a subset of current balancing circuits 506, e.g., excluding the (active) current balancing circuits 506 having the lowest and highest value V_{CS_FILT}, etc.

In various embodiments, based on the connection to the input terminal of the operational amplifier 2250, the delay line 2244 may be provided for the clock signal CF or CR. For example, in the embodiment considered, the delay line 2244 receives the clock signal CF and generates a delayed clock signal CF’, which represents the control path of the regulation. In various embodiments, the other clock signal may also be delayed. For example, in the embodiment considered, the current balancing circuit 506 comprises a delay line configured to receive the clock signal CR and generate a delayed clock signal CR’. For example, in the embodiment considered, the current balancing circuit 506 comprises a bias current source 2254 configured to generate a (constant) current I_{B}, wherein the current I_{B} is provided to the delay line 2246.

Thus, in various embodiments, one or more delay lines 2244 and/or 2246 may be coupled between the input terminals of the phase detector 2230 and the terminals arranged to receive the respective clock signals CF and CR, wherein the delay of at least one of the delay lines 2244 and/or 2246 is varied in order to regulate the average current to a requested value V_{CS_REF}. For example, in the embodiment considered, the delay line 2244 receives the (regulated) current I_{CB} and the delay line 2246 receives the (constant) current I_{B}.

In this respect, the inventors have observed that that it is advantageous to apply regulation for the current balancing operation only to the delay-line 2244 in the control path while leaving unaffected the delay-line 2246 in the reference path, which permits to avoid any impact on the phase interleaving, i.e., in various embodiments, the corrective action for current balance is single-ended and not fully-differential.

The phase detector 2230 may be implemented in any suitable manner. For example, in various embodiments, the phase detector 2230 is implemented with a set-reset flip-flop receiving the signal CR’ at the set input and the signal CF’ at the reset input, wherein the output of the flip-flop provides the PWM signal DRV. For example, in various embodiments, the phase detector 2230 is configured to assert the PWM signal DRV in response to a rising edge of the clock signal CR’ and de-assert the PWM signal DRV in response to a rising edge of the clock signal CF’.

In various embodiments, in case of an analog error amplifier, the current balancing circuit 506 may comprise an electronic switch 2256 configured to reset the voltage at the capacitance C_{B} to a pre-charge value V_{PC} as a function of a pre-charge signal PC. In various embodiments, the pre-charge signal PC may be common for all current balancing circuits 506 or each current balancing circuits 506 may receive a respective pre-charge signal PC.

Accordingly, in the embodiment considered, the (common) regulator 500 is a time-based (I, PI, DI or PID) regulator configured to implement the regulation of the output voltage Vₒᵤₜ, and each current balancing circuit 506 comprises one or more additional delay lines 2244 and/or 2246 and a further regulator configured to implement the current balancing operation.

In various embodiments, at least part of the delay lines of the PID regulator 500 may also be combined with the delay lines 2244 and/or 2246, e.g., the derivative component and/or the proportional regulation of the regulator may be used to vary the delay introduced by the delay lines 2244 and/or 2246. For example, this is shown in FIG. 17.

Specifically, in various embodiments, the delay lines 2244 and/or 2246 may also receive an additional current I_{F} and/or I_{R} used to implement the proportional and/or derivative output voltage regulation. For example, in various embodiments, the delay line 2244 receives a current corresponding to (I_{CB} + I_{F}) and the delay line 2246 receives a current corresponding to (I_{B} + I_{R}).

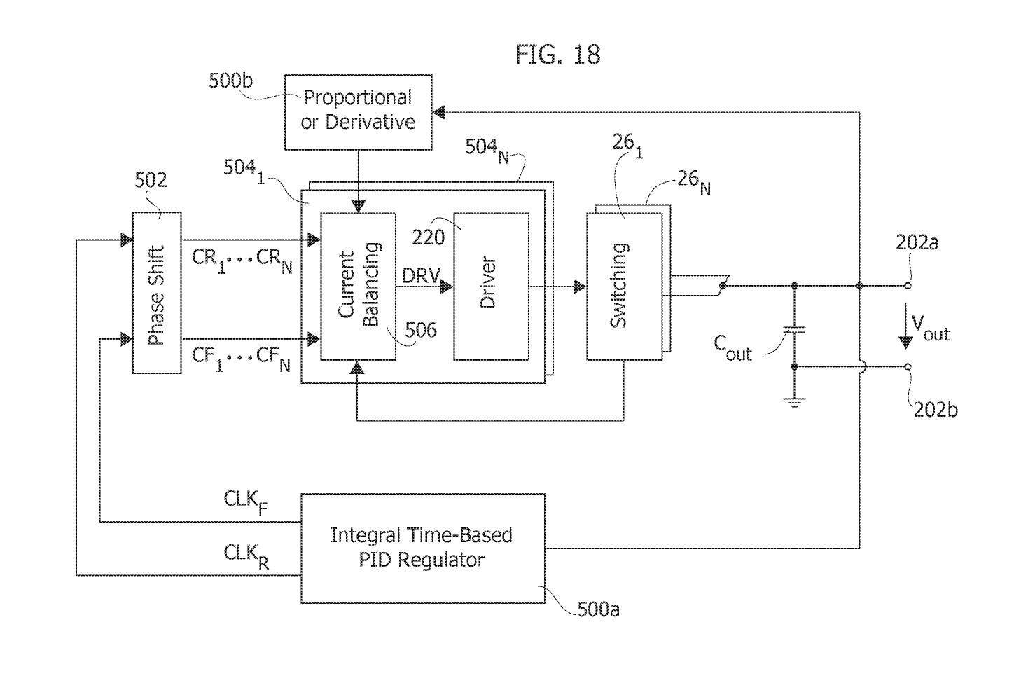

For example, this is also shown in FIG. 18. Specifically, in the embodiment considered, the time-based PID regulator 500 has been split into two circuits 500a and 500b. For example, in various embodiments, the regulator circuit 500a implements only the integral component, while the regulator circuit 500b (together with the delay lines 2244 and/or 2246) implements the proportional and/or derivative component.

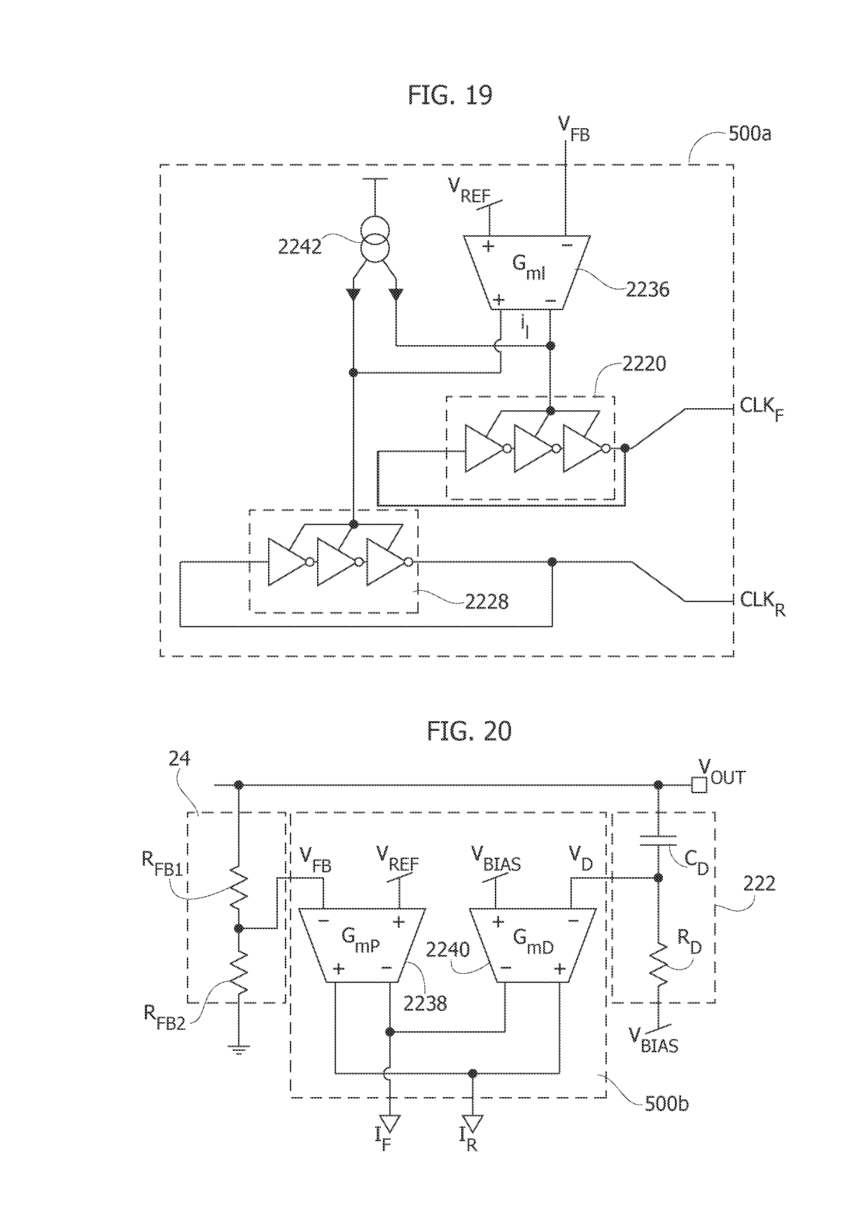

For example, FIG. 19 shows an embodiment of the regulator circuit 500a, which uses a differential configuration as shown in FIG. 11, i.e., the regulator circuit 500a comprises the oscillators 2220 and 2228 and the transconductor 2236, wherein the oscillator 2220 is configured to generate the clock signal CLK_{F} and the oscillator 2228 is configured to generate the clock signal CLK_{R}. As mentioned before, the transconductor 2236 may also have associated a common mode current source, which is shown in FIG. 19 with the reference signal 2242.

Alternatively, in various embodiments, the configuration shown in FIG. 9 is used, i.e., the circuit 500a may comprise the oscillator 2220 configured to generate the clock signal CLK_{F} and the oscillator 2228 configured to generate the clock signal CLK_{R}. wherein the frequency of the oscillator 2220 is varied as a function of the feedback signal FB.

FIG. 20 shows an embodiment of the circuit 500b. Specifically, in the embodiment considered, the circuit 500b uses the differential configuration, i.e., the circuit 500b is configured to generate a current I_{F} and a current I_{R}.

Accordingly, based on whether the circuit 500b implements the proportional and/or derivative components, the circuit 500b may comprise the transconductor 2238 for the proportional component and/or the transconductor 2240 for the derivative component, e.g., the current I_{R} may correspond to i_{P+}, i_{D+} or (i_{P+} + i_{D+}) and the current I_{F} may correspond to i_{P-}, i_{D-} or (i_{P-} + i_{D-}), respectively. Specifically, in the embodiment considered, the circuit 500b comprises the transconductors 2238 and 2240, whereby the delay line 2244 receives a current corresponding to (I_{CB} + I_{F}) = (I_{CB} + i_{P-} + i_{D-}) and the delay line 2246 receives a current corresponding to (I_{B} + I_{R}) = (I_{B} + i_{P+} + i_{D+}).

Accordingly, in the embodiment shown in FIG. 20, the time-based integral (I) control part is centralized via the regulator circuit 500a and is common to all phases. Conversely, the proportional (P) and/or the derivative (D) actions are partially centralized (i.e., common to all phases) via the circuit 500b and partially implemented locally/dedicated within each single phase via the delay lines 2244 and 2246 within the current balancing circuits 506.

For example, in the embodiment shown in FIG. 20, the two transconductors 2238 and 2240 generate the required proportional and derivative actions in form of current information (i_{P} and i_{D}), which are common to all phases. Specifically, while FIG. 18 shows that the circuit 500b provides a single signal to all current balancing circuits 506, indeed the circuit 500b may be configured to provide to each current balancing circuit 506 a respective current I_{F} and a respective current I_{R}. For example, for this purpose, circuit 500b may comprise a current mirror configured to generate for each current balancing circuit 506 a respective current I_{F} and a respective current I_{R}. Alternatively, already the transconductors 2238 and 2240 may comprise current mirrors and generate for each current balancing circuit 506 respective differential currents i_{P} and i_{D}. Alternatively, in various embodiments, a respective circuit 500b may be implemented in each current balancing circuit 506. However, in this case, the feedback circuits 24 and 2222 may still be shared for all circuits 500b. For example, such "local" circuits 500b may be advantageous in order to minimize the parasitic effects of the connections to the delay-lines 2244 and/or 2246, which may introduce undesired poles and permit to reduce cross-talks between phases.

Conversely, in the solution shown in FIG. 16, the proportional and derivative components are centralized in PID regulator 500, and the delay lines 2244 and/or 2246 are just used for the current balancing operation.

In both embodiments, the current balancing circuit 506 is configured to monitor the current provided by each phase 26 and then close a negative feedback loop acting locally on the duty-cycle of each single-phase. Within the single-phase the current provided by the respective phase 26 is compared with a reference signal V_{CS_REF} and a corrective action is obtained via the error amplifier 2250. For example, as mentioned before, the action can be purely integral or proportional-integral.

In various embodiments, this action is then applied, e.g., via the current I_{CB}, to the delay-line 2244 configured to delay the clock signal CF, which represents the control path. In such a way, the duty-cycle of the single-phase is corrected by properly shifting the signal CF’. As mentioned before, preferably a single-ended configuration is used for the corrective action of the current balancing mechanism.

In each single phase 26 a current sensor is used to obtain the value CS of the current provided by the respective switching stage 26, e.g., the current I_{L}. Such information may then be processed, e.g., low-pass-filtered to obtain the average current signal V_{CS_FILT}. Regarding the current-sensor, different circuits and implementations are known in the art (see also the description of FIG. 6). Full-wave current-sensors can be used, alternatively employing current-sensor circuits only on the high-side or low-side switch is possible. Moreover, it is also possible to exploit current-sensing circuits that inherently provide the average current information.

Then, an error-amplifier 2250 (e.g., an OTA) is exploited to compare the signal V_{CS_FILT}, e.g., indicative of the average coil current, with a given reference V_{CS_REF}, which is the same for all the phases. In various embodiments, the error amplifier 2250 converts the error voltage (i.e., the difference between V_{CS_REF} and V_{CS_FILT}) in an error current signal, which is then integrated on an integral (type-I) filter or a proportional-integral (type-II) filter and a control voltage V_{EA} is obtained. In various embodiments, this control voltage V_{EA} is converted into a current I_{CB} by means of a voltage-to-current conversion circuit 2252. The current I_{CB} is then provided to the delay-line 2244, which is preferably arranged in the control path. In this way, a proper and dedicated phase shift is introduced between the clock signals CF’ and CR’, which allows to fine tune the duty-cycle of each phase.

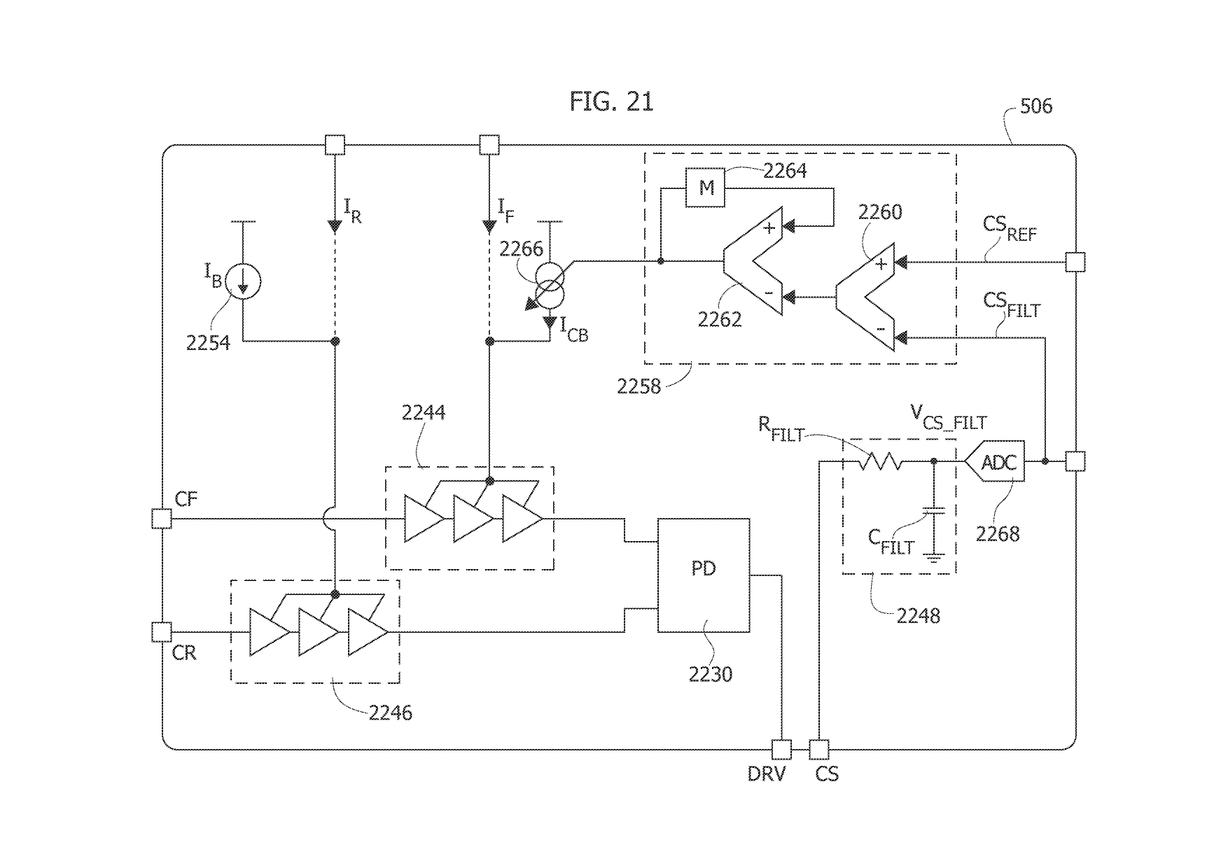

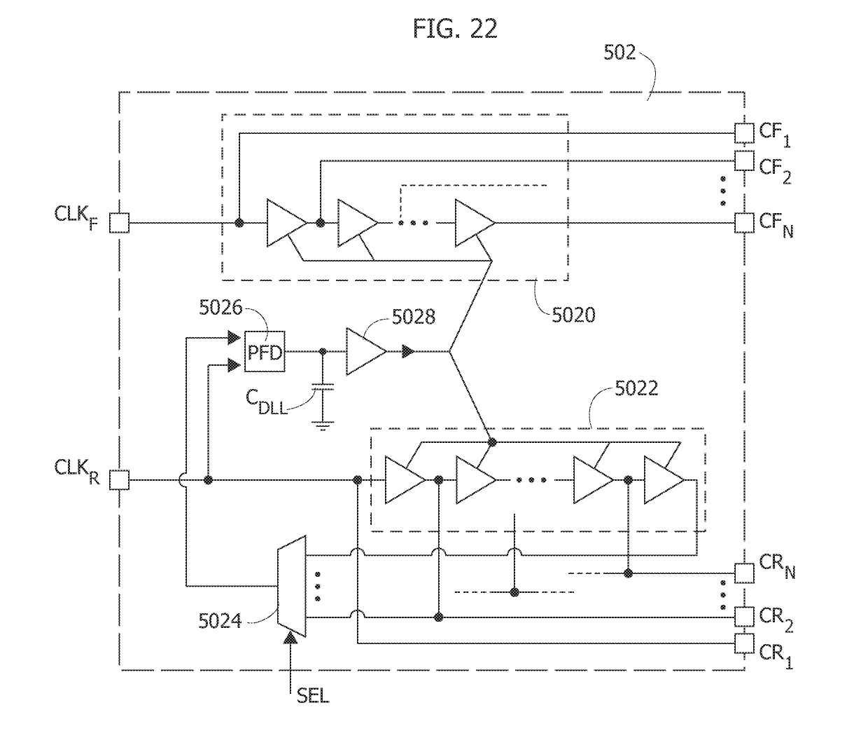

While FIG. 17 shows an analog implementation of the current balancing regulator, also a digital implementation may be used. For example, FIG. 21 shows an embodiment, wherein an analog-to-digital converter (ADC) 2268 is configured to generate digital samples CS_{FILT} by sampling the voltage V_{CS_FILT} provided by the filter circuit 2248. However, the ADC 2268 may also sample directly the signal CS and optionally implement the filter circuit 2248 via digital processing.

Accordingly, in the embodiment considered, the sample CS_{FILT} and a reference value CS_{REF} are provided to a digital regulator circuit 2258. For example, in line with the previous description, the reference value CS_{REF} may correspond to the sample CS_{FILT} of a given phase control circuit 504, such as the phase control circuit 504₁, or an average value of the samples CS_{FILT} of one or more (active) phase control circuits 504.

For example, in the embodiment considered, the digital regulator 2258 may be implemented via a digital hardware circuit or via software instructions. For example, in the embodiment considered, the regulator circuit 2258 comprises a subtraction circuit module 2260 configured to calculate an error value based on the difference between the reference value CS_{REF} and the value CS_{FILT}. Next, the error value is provided to a digital accumulator circuit or module, e.g., comprising an adder 2262 and a memory (M) 2264. Accordingly, in the embodiment considered, the value at the output of the regulator 2258 corresponds to the sum of the error values, thereby implementing an integral regulator.

Accordingly, in the embodiment considered, the value at the output of the regulator 2258 may be provided to a current digital-to-analog converter (IDAC) 2266 configured to generate the current I_{CB}.

In various embodiments, the ADC 2268 and the subtraction circuit 2260 may also be combined and implemented with a comparator, which thus signals whether the voltage V_{CS_FILT} at the output of the filter circuit 2248 is above or below the reference voltage V_{CS_REF}. In fact, this permits to implement an ADC with a single bit. Accordingly, in this case, the regulator 2258 may be configured to add to the value stored to the memory 2264 a given positive value when the output of the comparator indicates that voltage V_{CS_FILT} at the output of the filter circuit 2248 is below the reference voltage V_{CS_REF}, and a given negative value when the output of the comparator indicates that voltage V_{CS_FILT} at the output of the filter circuit 2248 is above the reference voltage V_{CS_REF}.

In various embodiments, the current-controlled-delay-lines 2244 and 2246 are biased with a common-mode current, labelled as I_{B}, which allows the system to introduce both positive and negative phase-shifts, because the currents i_{P} and i_{D} can be either positive or negative.

Specifically, in the embodiment shown in FIG. 17, only the delay-line 2246 in the reference path is biased with the current I_{B}, while the bias current for the delay line 2244 in the control path is provided indirectly via the current-balancing operation. In this case, the conversion circuit 2252 is not required to generate bidirectional currents (e.g., the circuit 2252 may be implemented with a source follower stage). However, in this case, it may be useful to pre-charge the voltage V_{EA} (i.e., preset/initialize the integrator) to a given voltage V_{PC}. For example, in FIG. 17 is shown the electronic switch 2256 for this purpose.

Alternatively, in various embodiments, an additional bias current source may be used to provide a current I_{B} to the output of the conversion circuit 2252, whereby the input of the delay-line 2244 receives the bias current I_{B} and the current I_{CB} provided by the conversion circuit 2252. In this case, the current conversion circuit 2252 should be able to provide both positive and negative corrective currents I_{CB}.

As mentioned before, various solutions may be used to determine the reference signal V_{CS_REF} or the reference value CS_{REF}. The simplest approach is to define the first phase as the master (or principal), meaning that V_{CS_REF} corresponds to the signal V_{CS_FILT} of the first current balancing circuit 506₁. In this case, the current-balance loop may be turned-off within the first phase (or even omitted), while in all the other phases (i.e., secondary or slave phases) the current-balance loops align the average current of each-phase to the one of the principal phase. The main drawback of this approach is that for stability reasons the current-balance loop has to be designed to have a much lower bandwidth with respect to the outer (Vₒᵤₜ) DC-DC converter loop. However, the control circuit 50 may also be configured to sum all the current information of all the phases to obtain an averaged current that is then used as reference V_{CS_REF}.

Concerning the embodiment shown in FIG. 18, the delay lines 2244 and 2246 used for the current balancing operation may also be in addition to the delay lines 2224, 2226, 2234 and/or 2235 used for the proportional and integral regulation of the output voltage Vₒᵤₜ, i.e., the current balancing circuit 506 may also comprise one or more additional delay lines driven as a function of the feedback signals FB and V_{D}. Those of skill in the art will appreciate that the solution shown in FIG. 17 has less complexity, because it permits to use the same delay-lines with the time-based controller and the current-balance loop. However, by adding one or more further delay lines, the action of the current-balance loop may be separated from the operation of the time-based controller, e.g., the current I_{F} may be provided to an additional delay line connected in series with the delay line 2244 and I_{R} may be provided to an additional delay line connected in series with the delay line 2246. This scenario may be preferable if the delay-lines have a limited dynamic range and/or their gains requested by the time-based controller are contradictory with the current-balance loop requirements. To minimally affect the loop stability, the two delay-lines 2244 and 2246 are preferably placed in series prior to the additional delay-lines exploited by the time-based controller. In this way, the PD actions (which are "fast actions") of the time-based controller does not experience any extra delay and there is no stability penalty.

Accordingly, in the embodiments described in the foregoing, the regulator circuits 500 and 500a generate the clock signals CLK_{F} and CLK_{R} by using at least the integral component. The phase shift circuit 502 is configured to generate N interleaved versions of the clock signals CLK_{R} and CLK_{F}. For example, the various clock signals CF (and similarly CR) may be equally spaced by 2π/N. This means that the phase shift between each couple of clock signals CFᵢ and CRᵢ corresponds to the one originally defined by the clock signals CLK_{R} and CLK_{F} and therefore the duty-cycle provided at the input of each phase control circuit 506 is the same. Then, within each phase control circuit 506, a specific correction action is generated by each current-balancing loop to create the dedicated duty-cycle shift respect to the original duty-cycle centrally provided. As mentioned before, the proportional and/or derivative control may be implemented before the phase shift circuit 502, e.g., within the circuit 500, or after the phase shift circuit 502, e.g., within the circuit 500b.

With respect to FIG. 22, a possible embodiment of phase shift circuit 502 is provided. In general, this phase shift circuit 502 may also be used in the arrangement of Kim et al., i.e., the specific phase shift circuit 502 and the current balancing loop may be used separately or in combination.

Specifically, the circuit shown in FIG. 22 essentially implements a particular delay-locked-loop (DLL) having two paths, called Dual-Path DLL. This is exploited to generate N equally spaced (i.e., interleaved) versions of the clock signals CLK_{R} and CLK_{F} provided by the regulator 500 or 500a.

Specifically, in the embodiment considered, the phase shift circuit 502 comprises a first set of N delay lines 5022 connected in cascade, wherein the first delay line 5022 is configured to receive the clock signal CLK_{R}, whereby the delay lines 5022 generate delayed versions of the clock signal CLK_{R}. The output of one or more of the delay lines 5022 are fed to a multiplexer 5024, which selects one of the signals as a function of a selection signal SEL. The output of the multiplexer and the clock signal CLK_{R} are provided to a phase detector or a phase-frequency-detector (PFD) 5026, which drives a charge pump to charge and discharge a capacitance C_{DLL} in order to align the rising edge of the clock signal CLK_{R} with the rising edge of the clock signal provided by the multiplexer 5024. Finally, the delay introduced by each delay line 5022 is controlled as a function of the voltage at the capacitance C_{DLL}. For example, in the embodiment considered, the delay lines 5022 are current-controlled delay lines, wherein the phase shift circuit 502 comprises a voltage-to-current conversion circuit 5028 configured to generate a supply current for the delay lines. In various embodiments, the conversion circuit 5028 may also comprise a current mirror configured to provide a respective supply current to each delay line 5022. Delay-locked loops are per se well-known in the art. For example, reference is made to Razavi, "The Delay-Locked Loop [A Circuit for All Seasons]," IEEE Solid-State Circuits Magazine, vol. 10, no. 3, pp. 9-15, Summer 2018, doi: 10.1109/MSSC.2018.2844615, which is incorporated herein by reference for this purpose.

Accordingly, by selecting via the multiplexer 5024 the output signal of the last delay line 5022, the charge pump 5026 will vary the voltage at the capacitance C_{DLL} and thus the delay introduced by the delay lines 5022 until the rising-edge of the last delay line 5022 is aligned with the rising-edge of CLK_{R} precisely with a delay of one clock period (i.e., 1/F_{SW}), i.e., the output signal of the last delay line 5022 has the same frequency as the clock signal CLK_{R} and a phase shift of 2π with respect to the clock signal CLK_{R}. Accordingly, in this case, the various delay lines 5022 provide clock signals having a phase shift of 2π/N with respect to the clock signal provided by the previous delay line 5022.

Thus, the control circuit 50 may enable a given number M of phase control circuits 506, with M ≤ N, and select via the selection signal SEL the output signal of the M-th delay line 5022. In this way, via the closed feedback, the phase shift circuit 502 will regulate the control signal, e.g., the power supply, of the delay lines 5022, such that each delay line 5022 introduces a phase shift of 2π/M with respect to the clock signal provided by the previous delay line 5022. Accordingly, in the embodiment considered, the clock signals CR₁ to CR_{N} may correspond to the input signals of the various delay lines 5022. Accordingly, when selecting a given number M, the respective clock signals CR₁ to CR_{M} are interleaved (i.e., equally spaced) with a phase shift of 2π/M, while the remaining clock signals CR_{M+1} to CR_{N} (if any) remain unused, because the respective phase control circuits 506 are disabled.

Accordingly, in the embodiment considered, the phase shift circuit 502 may also comprise a second set of (N-1) delay lines 5020 connected in cascade, wherein the first delay line 5020 is configured to receive the clock signal CLK_{F}, whereby the delay lines 5020 generate delayed versions of the clock signal CLK_{F}. Specifically, by supplying also the delay lines 5020 with the same control signal, e.g., power supply, as the delay lines 5022, each delay line 5020 provides the same delay as the delay line 5022. Accordingly, in the embodiment considered, the clock signals CF₁ to CF_{N-1} may correspond to the input signals of the various delay lines 5020, and the clock signal CF_{N} may correspond to the output signal of the last delay line 5020. Accordingly, when selecting a given number M, the clock signals CF₁ to CF_{M} are interleaved (i.e., equally spaced) with a phase shift of 2π/M, while the remaining clock signals CF_{M+1} to CF_{N} (if any) remain unused, because the respective phase control circuits 506 are disabled.

In the embodiment considered, the DLL is closed in feedback on the path of the clock signal CLK_{R}, because – as explained in the background section – in time-based DC-DCs the switching cycle starts at the rising-edge of the clock signal CLK_{R}, and therefore having clock signals CF precisely interleaved implies a precise phase interleave operation of the whole multiphase DC-DC.

In various embodiments, when using the current balancing circuit 506, the delay lines 5020 may also be omitted and the clock signals CF₁ to CF_{N} may correspond to the clock signal CLK_{F}. In fact, when the delay lines 5020 are omitted, each phase would be fed with different input duty-cycle, because the clock signals CR₁ to CR_{M} are interleaved and thus equally spaced by 2π/M. However, thanks to the presence of the current-balance loop within each current balancing circuit 506, the correct duty-cycle will be obtained for each phase, because the delay of the delay line 2244 is varied in order to obtain a requested current. However, such a solution may have the disadvantage that the current balancing loop should have a high dynamic range, which is usually not required for the current balancing operation.

The solutions disclosed herein provide various advantages over the prior-art solutions. First of all, by using the phase shift circuit 502 described with respect to FIG. 22, phase-interleaving is ensured, irrespective of the operative condition, external components, number of phases or PVT variations. The proposed implementation permits fine-grained phase-shedding (i.e., an arbitrary integer number of phase can be enabled without any restriction), and thus the DC-DC efficiency is maximized for a broad load range. These advantages are due to the exploitation of a dedicated DLL (i.e., Dual-Path DLL) placed after the integral control implemented in the regulator 500 or 500a.

The phase shift circuit of FIG. 22 operates at F_{SW}, since there are no frequency divider blocks. This translates in a reduced design complexity, without any upper limit posed by the number N.

Moreover, the phase shift circuit of FIG. 22 may use a variable number M of enabled phases. In fact, thanks to the common-mode action performed by the Dual-Path DLL, the triggered transient does not interfere/interact with the differential-mode action in charge of defining the duty-cycle of the DC-DC (as explained in the previous section). In this way, there is no interaction between the Dual-Path DLL loop and the DC-DC converter loop. This guarantees optimum dynamic performance, without any trade-off between bandwidth and stability.

Moreover, the control circuits 50 of FIGS. 17 and 21 behave as systems sampled at N ⋅ F_{SW}. In fact, it can be observed that the proportional and derivative actions are applied directly/immediately within the single/local phase. In fact, considering a perturbation, the transconductors 2238 and 2240 immediately provide a corrective action in the form of differential currents i_{P} and i_{D}. Now, these currents are immediately injected into all the delay-lines of each phase. Each delay-line, and therefore each phase, applies the corrective action creating a duty-cycle variation. Such duty-cycle correction is effectively applied to the DC-DC converter bridge with at maximum delay of 1/(N ⋅ F_{SW}).

Regarding the active current-balancing, the proposed solution ensures steady-state balanced (i.e., equalized) currents between phases, irrespective of the operative condition, external components, number of phases nor PVT variations. In various embodiments, this is due to the exploitation of a dedicated action exerted only on the delay-line 2244 in the control path (i.e., the one responsible for defining the end of the switch-on period T_{ON}). With the proposed current-balance solution the phase interleaving is not affected, since the delay-line in the reference path (i.e., the one responsible for defining the start of the switch-on period T_{ON}) remains unaltered by the current balancing operation.

The presented implementations are well suited for HFVR/FIVR and allow to fully exploit the benefits of a time-based control loop. In fact, the proposed solutions may be fully integrated on-chip and does not require any extra pad/pins, off-chip component, extra process mask and neither any trimming or calibration.

Of course, without prejudice to the principle of the invention, the details of construction and the embodiments may vary widely with respect to what has been described and illustrated herein purely by way of example, without thereby departing from the scope of the present invention, as defined by the ensuing claims.

For example, as mentioned before, while the control circuit 50 has been described primarily with respect to a multiphase buck converter, the control circuit 50 may also be used for other multiphase electronic converters, wherein a plurality of driver circuits 220 generate respective one or more driving signals for respective switching stages 26 as a function of a respective PWM signal DRV.

Moreover, as mentioned before, while reference has been made to a time-based PID regulator, the regulators 500 and 500a may also just comprise the integral component. For example, in this case the regulator 500b may be omitted, or may just implement the proportional or derivative component.

The scope of protection is defined in the appended claims, which form an integral part of the technical teaching of the description provided herein.

1. A control circuit for a multiphase electronic converter which includes a plurality of switching stages, the control circuit comprising:
a first regulator circuit including a first oscillator having an output coupled to a first output terminal configured to provide a first clock signal and a second oscillator having an output coupled to a second output terminal configured to provide a second clock signal;
wherein said first regulator circuit is configured to vary a switching frequency of one or more of said first clock signal or said second clock signal as a function of a feedback signal indicative of an output voltage provided by said multiphase electronic converter;
a phase shift circuit configured to generate for each switching stage of said plurality of switching stages a respective control clock signal and a respective reference clock signal, wherein each control clock signal has the switching frequency of said first clock signal, and wherein each reference clock signal has the switching frequency of said second clock signal and is phase shifted with respect to said second clock signal by a respective phase shift;
a phase control circuit for each switching stage, wherein each phase control circuit comprises a driver circuit configured to generate one or more drive signals for the respective switching stage as a function of a respective Pulse-Width Modulated (PWM) signal;
wherein each phase control circuit comprises a current balancing circuit comprising:
a first input terminal configured to receive a respective control clock signal from said phase shift circuit;
a second input terminal configured to receive a respective reference clock signal from said phase shift circuit;
a third input terminal configured to receive a signal indicative of a current provided by the respective switching stage;
a phase detector comprising a first input connected via one or more delay lines to the first input terminal of said current balancing circuit and a second input coupled to the second input terminal of said current balancing circuit, wherein said phase detector provides the PWM signal to the driver circuit of the respective phase control circuit; and
a second regulator circuit configured to vary a delay introduced by said one or more delay lines in order to balance the currents provided by the switching stages of said multiphase electronic converter.

2. The control circuit according to claim 1, wherein said first regulator circuit comprises:
one or more first delay lines connected between the output of said first oscillator and the first output terminal;
one or more second delay lines connected between the output of said second oscillator and the second output terminal;
wherein said first regulator circuit is configured to vary a delay introduced by said one or more first delay lines and/or said one or more second delay lines as a function of said feedback signal indicative of the output voltage.

3. The control circuit according to claim 1, wherein said first regulator circuit comprises:
one or more first delay lines connected between the output of said first oscillator and the first output terminal;
one or more second delay lines connected between the output of said second oscillator and the second output terminal;
wherein said first regulator circuit is configured to vary a delay introduced by said one or more first delay lines and/or said one or more second delay lines as a function of a further feedback signal indicative of the derivative of the output voltage provided by said multiphase electronic converter.

4. The control circuit according to claim 1, wherein said control circuit comprises a third regulator circuit configured to vary the delay introduced by said one or more delay lines of each current balancing circuit as a function of said feedback signal indicative of the output voltage provided by said multiphase electronic converter.

5. The control circuit according to claim 4, wherein said one or more delay lines of each current balancing circuit are current controlled delay lines, wherein said second regulator circuit is configured to provide a respective first current and said third regulator circuit is configured to provide a respective second current to said one or more delay lines of each current balancing circuit.

6. The control circuit according to claim 5, wherein the second input terminal of the phase detector is connected via one or more further delay lines to the second input terminal of said current balancing circuit, wherein said third regulator circuit is configured to provide a respective third current to said one or more further delay lines of each current balancing circuit.

7. The control circuit according to claim 6, wherein said one or more delay lines comprise a delay line configured to receive the sum of the respective first current and the respective second current, and/or said one or more further delay lines comprise a delay line configured to receive the sum of the respective third current and a bias current.

8. The control circuit according to claim 6, wherein said third regulator circuit comprises a first differential transconductor configured to receive said feedback signal and a first reference signal, and a second differential transconductor configured to receive said further feedback signal and a second reference signal, wherein said second current corresponds to the sum of a first current provided by the first differential transconductor and a first current provided by the second differential transconductor, and wherein said third current corresponds to the sum of a second current provided by the first differential transconductor and a second current provided by the second differential transconductor.

9. The control circuit according to claim 1, wherein said control circuit comprises a third regulator circuit configured to vary the delay introduced by said one or more delay lines of each current balancing circuit as a function of a further feedback signal indicative of the derivative of the output voltage provided by said multiphase electronic converter.

10. The control circuit according to claim 9, wherein said one or more delay lines of said current balancing circuits are current controlled delay lines, wherein said second regulator circuit is configured to provide a respective first current and said third regulator circuit is configured to provide a respective second current to said one or more delay lines of each current balancing circuit.

11. The control circuit according to claim 10, wherein the second input terminal of the phase detector is connected via one or more further delay lines to the second input terminal of said current balancing circuit, wherein said third regulator circuit is configured to provide a respective third current to said one or more further delay lines of each current balancing circuit.

12. The control circuit according to claim 11, wherein said one or more delay lines comprise a delay line configured to receive the sum of the respective first current and the respective second current, and/or said one or more further delay lines comprise a delay line configured to receive the sum of the respective third current and a bias current.

13. The control circuit according to claim 11, wherein said third regulator circuit comprises a first differential transconductor configured to receive said feedback signal and a first reference signal, and a second differential transconductor configured to receive said further feedback signal and a second reference signal, wherein said second current corresponds to the sum of a first current provided by the first differential transconductor and a first current provided by the second differential transconductor, and wherein said third current corresponds to the sum of a second current provided by the first differential transconductor and a second current provided by the second differential transconductor.

14. The control circuit according to claim 1, wherein said second regulator circuit is configured to vary the delay introduced by said one or more delay lines in order to regulate the average value of the currents provided by the switching stages to a requested value.

15. The control circuit according to claim 14, wherein said requested value corresponds to an average value of the current provided by a reference switching stage of said switching stages or an average value of the currents provided by said switching stages.

16. The control circuit according to claim 1, wherein said phase shift circuit comprises:
N delay lines connected in cascade, wherein a first delay line of said N delay lines is configured to receive said second clock signal and said reference clock signals correspond to the input signals of said N delay lines;
a multiplexer configured to select an output signal of said N delay lines; and
a fourth regulator circuit configured to vary the delay introduced by each of said N delay lines, such that the rising edges of the signal provided by said multiplexer are aligned with the rising edges of the second clock signal.

17. The control circuit according to claim 16, wherein said phase shift circuit comprises additional N-1 delay lines connected in cascade, wherein a first delay line of said N-1 delay lines is configured to receive said first clock signal and said control clock signals correspond to the input signals of said N-1 delay lines and the output signal of the last delay line of said N-1 delay lines, wherein said fourth regulator circuit is configured to set the delay introduced by each of said N-1 delay lines to the delay introduced by each of said N delay lines.

18. An integrated circuit comprising the control circuit according to claim 1.

19. A multiphase electronic converter, comprising:
N switching stages, and
the control circuit according to claim 1.

20. A method of controlling a multiphase electronic converter, comprising:
driving a plurality of switching stages of said multiphase electronic converter via a control circuit according to claim 1.
